(19) United States
(12) Patent Application Publication
(10) Pub. No.: US 2025/0301440 A1
(43) Pub. Date: Sep. 25, 2025

(54) METHOD FOR CREATING A MODEL FOR POSITIONING, AND A METHOD FOR POSITIONING

(71) Applicant: Combain Mobile AB, Lund (SE)

(72) Inventors: Björn Lindquist, Bjärred (SE); Karl Åström, Lund (SE); Christoffer Kjellson, Lund (SE)

(73) Assignee: Combain Mobile AB, Lund (SE)

(21) Appl. No.: 19/233,221

(22) Filed: Jun. 10, 2025

Related U.S. Application Data
(63) Continuation-in-part of application No. 17/897,715, filed on Aug. 29, 2022.

(30) Foreign Application Priority Data
Aug. 31, 2021 (EP) 21194001.0

(51) Int. Cl. H04W 64/00; G01S 5/02

(52) U.S. Cl. CPC H04W 64/00; G01S 5/0258; G01S 5/0294; G01S 2205/02

(57) ABSTRACT

A method is provided for positioning of a device within an environment. The device may access a positioning model stored on the device, wherein the positioning model is based on training of positioning in the environment and represents characteristics of wireless signals in an area in which the device is located. The device may acquire sensor data by one or more sensors of the device, wherein the sensor data comprises position-dependent measurements for one or more positions of the device, wherein each position-dependent measurement relates to a wireless signal transmitted between the device and a radio transmitter arranged in the environment. The device may determine a location of the device within the environment based on inputting of the sensor data to the positioning model.

### CROSS-REFERENCE TO RELATED APPLICATIONS

This application is a continuation-in-part of U.S. Non-Provisional application Ser. No. 17/897,715, filed Aug. 29, 2022, which claims the benefit of European Patent Application No. 21194001.0, filed Aug. 31, 2021, the disclosures of which are incorporated herein by reference in their respective entireties.

### TECHNICAL FIELD

The present inventive concept relates, in general, to a method for creating a model for positioning and a method for positioning. More particularly, the present inventive concept relates to a machine learning model based localization system using multi-sensor data and, using training data with measured position and estimated position accuracy to create a model for localizing devices in an indoor environment.

### BACKGROUND

A positioning system enables a mobile device to determine its position. A positioning system may further make the position of the device available for position-based services such as navigating, tracking or monitoring, etc. Global Navigation Satellite Systems (GNSS), such as GPS, are the most widely used positioning systems. For small and low-cost battery-operated electronic devices, GPS may be expensive and draw too much power. GPS may also be hard to deploy for indoor use as line-of-sight transmission between receiver and satellite may be hard to achieve indoors.

There are a number of alternative positioning technologies for indoor positioning systems (IPS) such as infrared (IR), ultrasound, radio-frequency identification (RFID), wireless local environment network (WLAN or Wi-Fi), Bluetooth, sensor networks, ultra-wideband (UWB), magnetic signals, visible light, vision analysis and audible sound.

One localization technique used for positioning with wireless access points (APs) and Bluetooth beacons is called fingerprinting and is based on an offline learning training phase of measuring the intensity of the received signal strength (RSS) in different defined positions and recording the “fingerprint” of RSS signals at that position in a database. When data is gathered in all positions, a device can look-up its position by recording the RSS “fingerprint” and compare it to the most similar fingerprints in the database. One way of doing this is the k-nearest neighbor (kNN) algorithm.

Although existing indoor positioning systems have many advantages, there are still improvements to be made.

### SUMMARY

It is an objective of the present inventive concept to enable accurate positioning of devices. It is a further objective of the present inventive concept to enable cost-effective positioning of devices. It is a further objective of the present inventive concept to make the positioning and/or the creation of a model for positioning computationally efficient and thereby also power efficient and cost efficient. It is further an objective to enable automated creation of indoor positioning. Automated creation of indoor positioning may facilitate the creation of a global indoor positioning service. These and other objectives of the inventive concept are at least partly met by the invention as defined in the independent claims. Preferred embodiments are set out in the dependent claims.

The methods discussed herein facilitate accurate indoor localization globally and may be used for positioning of both advanced devices like smartphones and simple wireless Internet of Things devices. Thus, the methods may use existing infrastructure in the buildings (Wi-Fi APs, Bluetooth beacons) and be able to position low-cost wireless devices (Wi-Fi receivers, Bluetooth receivers) with no extra hardware added.

According to a first aspect, there is provided a method for creating a model for positioning within an environment, the method comprising:
receiving a training dataset comprising samples of an estimation labeled type, each sample of the estimation labeled type being associated with a measurement position in the environment, each sample of the estimation labeled type comprising
   sensor data, measured at the measurement position associated with the sample, the sensor data being characteristic of the measurement position associated with the sample;
   an estimated measurement position, being an estimate of the measurement position associated with the sample;
   an estimated accuracy, being an estimate of an accuracy of the estimated measurement position;
training a machine learning model to convert sensor data to a position in the environment, wherein the training is based on the samples of the estimation labeled type in the training dataset, whereby the model for positioning within the environment is created.

The machine learning model may be any kind of model created through training using a training dataset. The machine learning model may be an artificial neural network. In the following, the machine learning model will predominantly be described as an artificial neural network (for convenience simply called neural network). As an alternative, the machine learning model may be e.g. a decision tree, a model based on decision trees such as a random forest, a support vector machine, or a Bayesian network.

It should be understood that the environment for the positioning may be a building. Further, the estimated measurement position may include a height or a floor indicator. The method may be particularly advantageous for creating a model for indoor positioning as GPS works poorly or not at all inside buildings. Further, when the estimated measurement position includes a height or a floor indicator, positioning in multi-story buildings is enabled. The text mainly focuses on indoor positioning, but it is to be understood that the methods also work for outdoor positioning, e.g. outdoor positioning of devices that do not use GPS or similar techniques.

The sensor data of at least one sample may comprise distance dependent data, the distance dependent data comprising an indication of a distance between the measurement position associated with the at least one sample and a radio transmitter.

An indication of a distance may not necessarily be a direct measure of a distance. Rather, the indication of a distance may be a quantity that is dependent on distance in some way. The measured quantity need not even be directly proportional to the distance and may even be non-linearly related to the distance. As further described below, the distance measurement may be based on a received signal strength, e.g. a received power of a signal, or be based on a time of travel of a signal between a source and a receiving unit. Also, the distance dependent data may be represented in a non-linear scale, such as a logarithmic scale.

The sensor data may comprise received signal strength (RSS) data from one or more radio transmitters in the environment.

The sensor data of a sample may comprise RSS data which indicates a distance between the measurement position associated with the sample and a radio transmitter. The measured signal strength of a radio transmitter may decay with increasing distance from the radio transmitter, e.g. decay exponentially. Thus, the distance between the radio transmitter and the measurement position where the RSS data was measured may be calculated from the received signal strength and the equation for the expected exponential decay. In order to exemplify the inventive concept, the training data set will mainly be described as a data set wherein each sample comprises sensor data in the form of RSS data. However, it should be understood that any one of the samples of the training data set may additionally, or alternatively, comprise other sensor data.

It is a realization that estimated measurement positions may be used to create a model for positioning within an environment. It may not be necessary to create the model based only on known measurement positions. A model based on estimated measurement positions may still be accurate. A model based on estimated measurement positions may in fact be more accurate than a model based only on known measurement positions, at least under some circumstances. Estimated measurement positions may be more readily available than known measurement positions. Thus, basing the model on estimated measurement positions may mean that more data samples can be used. For example, through crowdsourcing a large number of samples comprising sensor data and estimated measurement positions may become available. Although the measurement data in such samples may not be trusted fully, and as such be considered as estimated measurement positions, the sheer number of data samples becoming available may make the model accurate.

If one treats estimated measurement positions the same way as one would treat known measurement positions when creating the model, errors may be introduced in the model. The negative impact on the model from said errors may outweigh the positive impact of more samples being available. An important realization is thus that an estimate of an accuracy of the estimated measurement position, i.e. an estimated accuracy, may be used to mitigate the negative impact on the model from said errors.

Specifically, the use of an estimated accuracy may allow various types of positioning sources to be utilized instead of just manually created training data which by design may have a very high accuracy of the position but may be expensive to acquire. For example, GPS data with lower accuracy or other indoor positioning methods like inertial navigation or bundling optimization as outlined in patent EP3093683, may be used to determine estimated measurement positions.

It is a realization that a model for positioning within an environment may advantageously be created through the training of a machine learning model such as e.g. a neural network. A model created through the training of a neural network may be accurate as a neural network may find data relationships that are overlooked by humans. Creating a model through the training of a neural network may be cost-effective as little manual fine tuning of the model may be required. It is a further realization that rethinking conventional teachings of what a neural network training dataset should comprise facilitates further improvements in accuracy and cost efficiency.

To illustrate some of the advantages of the inventive concept, a way of creating a model using conventional teachings of neural networks will first be described in what we may label as “an example in line with conventional teachings”. It should be noted that said example is given without conceding that the example in itself is part of prior art. Then, an example of a method according to the inventive concept will be described.

As an example in line with conventional teachings consider trying to create a model for positioning within a building, wherein the model is to be used for positioning of mobile phones within the building. As previously described, GPS signals may not be readily available within the building, e.g. close to windows etc. Instead, Wi-Fi access points (APs) in the form of Wi-Fi radio transmitters may be readily available in buildings and may be used. A dataset of samples may be collected wherein each sample corresponds to a measurement position in the building and each sample comprises sensor data in the form of RSS data, such as one or more RSS signals, and the known measurement position. A neural network may then be trained to convert RSS data to a position in the building. The neural network may thus, through the training dataset, “learn” the relationship between RSS data and measurement positions. In such training the dataset may, in line with conventional teachings, be used with the RSS data as features and the known positions as labels, the dataset may thus be considered to comprise samples of a labeled type. During conventional neural network training the validity and/or quality of a sample is generally not questioned and the labels are taken as ground truth. Therefore, great care may need to be taken in forming the training dataset. Training in line with conventional teachings may thus require rather large efforts in gathering the samples. In principle it may be necessary to manually create the dataset, e.g. by physically going to the building and systematically recording the RSS data at various known positions inside the building.

As an example of a method according to the inventive concept, a model for positioning within a building may be created using other data than systematically manually created data. For example, crowdsourced data may be used to create the training dataset. People may walk through the building back and forth every day and their mobile phones may be able to record RSS data at various positions and create vast amounts of data. Such data may be used to create the model for positioning. However, even though each piece of RSS data is associated with a measurement position, said measurement position may not be known, as the GPS of the mobile phone may not work, or work poorly, in the building. Thus, according to conventional teachings it may be hard, or impossible, to create an accurate model by training a neural network on such data.

Different ways of estimating the measurement position will be described below. As previously discussed, if these estimates are presented as ground truth to the neural network, e.g. if each sample of the training dataset would comprise only sensor data and an estimated measurement position (but not including an estimated accuracy), they may do more harm than good. In contrast, when samples of the training dataset comprise sensor data, an estimated measurement position, as well as an estimated accuracy, it enables the training of the neural network to give a higher weight to more accurate measurement positions and still use low accuracy measurement positions to contribute to a better overall positioning.

The sensor data is characteristic of the measurement position associated with the sample. Such sensor data may be any kind of sensor data that changes with the measurement position. The sensor data may be characteristic of the measurement position by indicating that the measurement position belongs to a subset of measurement positions within the environment. For example, the sensor data may be characteristic of the measurement position by indicating that the measurement position is at a certain distance from a radio transmitter. In this example all measurement positions at said distance from the radio transmitter may be seen as belonging to the subset of measurement positions. The sensor data may, as previously mentioned, comprise distance dependent data and/or RSS data. But sensor data could, alternatively or additionally, be any other sensor data that changes with position. In one example, sensor data may comprise distance dependent measurements like round trip time, RTT, to WiFi APs. RTT may be the time it takes for a network request to go from a device to a WiFi AP and back again. In another example, sensor data may comprise UWB distance measurements to UWB beacons. In another example, sensor data may comprise light sensor data, e.g. light sensor data of a modulated light fingerprint. Light, e.g. invisible light, may be modulated in different ways in different locations of a building and thereby form a fingerprint of the location. Similarly, sensor data may comprise audio data. Sound, e.g. sound not perceivable by humans, may be modulated in different ways in different locations of a building and thereby form a fingerprint of the location. Sensor data may, additionally or alternatively, comprise data from pressure sensors which indicates height.

It should also be clear that sensor data does not necessarily have to be an absolute value. Sensor data could be a relative value measurement, for example pressure difference compared to walking into a building, RSS difference measured relative to strongest RSS value measured at the location, and so on.

Sensor data may comprise one or more entities of data. For example, sensor data may comprise one RSS measurement to one single radio transmitter. In another example, sensor data may comprise a plurality of RSS measurements, wherein each RSS measurement corresponds to a separate radio transmitter. Such a plurality of RSS measurements may be seen as a fingerprint of a location.

Sensor data may comprise one type of sensor data, e.g. only RSS data, or any combination of types of sensor data, e.g. a combination of RSS data and RTT data, or a combination of RSS data, light sensor data, and audio data. Just like combinations of several entities of sensor data, sensor data of the same type may be seen as a fingerprint of a location, combinations of sensor data of different types may be seen as a fingerprint of a location.

The estimated measurement position may be a 2D estimated measurement position, e.g. comprising latitude and longitude, or comprising a x value and a y value corresponding to coordinates in a 2D coordinate system.

Alternatively, the estimated measurement position may be a 3D estimated measurement position, e.g. comprising latitude, longitude, and altitude, or comprising a x value, a y value, and a z value corresponding to coordinates in a 3D coordinate system. The altitude or z value may be meters above ground level, meters above sea level, or the floor of a building, e.g. ground floor, first floor etc.

The estimated accuracy is an estimate of an accuracy of the estimated measurement position. The estimated accuracy may be a single figure like the average horizontal accuracy figure in meters or a figure like horizontal dilution of precision (HDOP) for GPS receivers or an accuracy in three dimensions, x, y and z. As an example, in a bundle optimization positioning algorithm, variance in x and y respectively and an estimated floor accuracy may be obtained. The estimated accuracy may be represented in many ways, e.g. as the inverse of a standard deviation, as the inverse of a variance, or as an inverse of a covariance matrix. Alternatively, the estimated accuracy may be represented as one or more standard deviations or as a variance. There are a number of different ways for different indoor positioning systems to calculate the estimated accuracy or estimated error of a positioning estimate, and all of these can be used in the scope of this patent.

### Setting Estimated Measurement Position and Estimated Accuracy of a Sample

The method may comprise setting the estimated measurement position and the estimated accuracy of each of a plurality of samples of the estimation labeled type in the training dataset. This may be done in many different ways as there are many different indoor positioning systems (IPS), some of which are described below.

Setting the estimated measurement position and the estimated accuracy of each of a sample of the estimation labeled type in the training dataset may be done by:
receiving a model of estimated radio transmitter positions in the environment;
calculating the estimated measurement position and the estimated accuracy to be set for said sample of the estimation labeled type based on distance dependent measurements to the transmitters and the model of estimated radio transmitter positions.

For example, if a number of distance dependent measurements, such as RSS measurements have been collected at a measurement position, e.g. by a mobile phone contributing in a crowdsourcing scheme, the measurement position may be estimated by a trilateration calculations if estimates of the radio transmitter positions are available from a model of estimated radio transmitter positions.

It is herein important to note that the radio transmitter positions may not be fully known themselves but indeed be estimates of the radio transmitter positions. An estimate of the accuracy of the estimated measurement position, i.e. the estimated accuracy, may then be calculated using the accuracy of the estimated radio transmitter positions. The RSS measurements, the calculated estimated measurement position and the calculated estimated accuracy may then together form a sample for the training dataset.

It should also be noted that even if the model of estimated radio transmitter positions does not explicitly comprise accuracies for the estimated radio transmitter positions an estimated accuracy of the measurement position may still be calculated. For example, in 2D three distance dependent measurements should through triangulation intersect in one point, the estimated measurement position. However, due to inaccuracies in the estimated radio transmitter positions and/or the modelling of the indoor environment (walls etc.), they may intersect to form an area. Such an area may also be an estimate of the accuracy of the estimated measurement position.

The distance dependent measurements to the transmitters that are used to calculate the estimated measurement position may be e.g. RSS measurements, RTT measurements to WiFi APs, UWB distance measurements to UWB anchors, etc.

As described above, the distance dependent measurements to the transmitters that are used to calculate the estimated measurement position of the sample may also be used as the sensor data of the sample. Alternatively, or additionally, other types of sensor data may form the sensor data of the sample. To exemplify:

A sample may comprise RSS data and an estimated measurement position and estimated accuracy calculated from said RSS data. A neural network trained on such samples may create a model for positioning using RSS data.

Alternatively, a sample may comprise light sensor data and an estimated measurement position and estimated accuracy calculated from RSS data measured at the same measurement position as the light sensor data. A neural network trained on such samples may create a model for positioning using light sensor data. A simple device which can only orient itself using light sensor data may then benefit from a model which has been created from data acquired by more advanced devices which can measure both light sensor data and RSS data.

Alternatively, a sample may comprise light sensor data and RSS data acquired at the same measurement position, and an estimated measurement position and estimated accuracy calculated from RSS data and/or the light sensor data.

Generating the model of estimated radio transmitter positions may be done by:
receiving radio transmitter modelling samples, each radio transmitter modelling sample being associated with a measurement position in the environment or in the vicinity of the environment, each radio transmitter modelling sample comprising:
   distance dependent data, measured at the measurement position associated with the radio transmitter modelling sample, the distance dependent data comprising an indication of a distance between the measurement position of the radio transmitter modelling sample and a radio transmitter;
forming a candidate model of estimated radio transmitter positions and estimated measurement positions of the radio transmitter modelling samples based on the received radio transmitter modelling samples and a plurality of defined positions for samples and/or for radio transmitters;
iteratively reducing a sum of residuals for said candidate model, wherein at least one residual is based on, for at least one sample of the received radio transmitter modelling samples, a difference between an estimated distance between the measurement
   position of said at least one sample and a radio transmitter as represented by the model and
   a measured distance between the measurement position of said at least one sample and the radio transmitter as represented by the distance dependent data of said at least one sample, for generating a model of estimated radio transmitter positions.

Thus, the model of estimated radio transmitter positions may be generated by bundle optimization, as described in EP3093683, which is herein included by reference. In particular, [0047-0061] of EP3093683 is included by reference, describing details of how the model of estimated radio transmitter positions may be created.

It should be clear that forming the candidate model of transmitters could also be made by using other data than only distance dependent data, for example also by using GNSS data and/or IMU data to more accurately estimate measurement positions and thereby forming a better model of radio transmitter positions.

The radio transmitter modelling samples may be samples obtained through crowdsourcing, e.g. from mobile phones moving around in a building. The radio transmitter modelling samples may comprise distance dependent data in the form of RSS data. From such samples it may be possible to generate the model of estimated radio transmitter positions as described in the first aspect in EP3093683. The model of estimated radio transmitter positions may become more and more accurate the more radio transmitter modelling samples are inputted. Thus, accuracy of the estimated radio transmitter positions may become better and better. Then the model of estimated radio transmitter positions may be used to estimate measurement positions. Thus, the model of estimated radio transmitter positions may, in itself, be used for positioning.

It is now a realization that instead of continuing to feed the model of estimated radio transmitter positions with more and more distance dependent data it may be possible to halt the evolution of the model of estimated radio transmitter positions at a relatively early stage. Newly collected distance dependent data may then together with the model of estimated radio transmitter positions be used to calculate estimated measurement position and estimated accuracy of the newly collected distance dependent data and be inputted into the training dataset of the neural network. Thus, using a first batch of distance dependent data to create the model of estimated radio transmitter positions and a second batch of distance dependent data to train the neural network may in the end create a more accurate model for positioning than using both the first and second batch to evolve the model of estimated radio transmitter positions.

Although the model of estimated radio transmitter positions may have inaccuracies, e.g. for certain radio transmitters and/or for certain sub-environments of the environment or building, those inaccuracies may be conveyed to the neural network through the estimated accuracy of each sample. Thus, the neural network may not be tainted by said inaccuracies. Instead, the neural network may be able to value each sample according to its estimated accuracy.

It should be understood that the model of estimated radio transmitter positions may be generated not only based on distance dependent data from unknown measurement positions. Some of the distance dependent data may be paired with known measurement positions, e.g. manual input of actual position or a valid GPS measurement at an entrance of the building where the accuracy of the GPS measurement is so good that it can be taken as ground truth and no accuracy may be needed. Alternatively, or additionally, some of the radio transmitters may have known positions. Such knowledge of a small number of measurement positions and/or radio transmitter positions may act as seeds of truth that allows the model of estimated radio transmitter positions to in the end become more and more accurate even if it is fed with distance dependent data from unknown measurement positions.

It should be understood that the estimated measurement position and the estimated accuracy of some, or all, samples of the training dataset may be set in other ways than using the model of estimated radio transmitter positions.

As an example, setting the estimated measurement position and the estimated accuracy of each of a plurality of samples of the estimation labeled type in the training dataset may be done by receiving Global Navigation Satellite System data for the measurement position.

The Global Navigation Satellite System (GNSS) data may be data from the global positioning system (GPS data), or the BeiDou Navigation Satellite System, or the Galileo navigation system etc.

Thus, sensor data may be measured at a measurement position and GNSS data may be acquired at the same position, e.g. by the same device acquiring the sensor data. The estimated measurement position may herein be the GNSS position. The estimated accuracy may herein be the horizontal dilution of precision (HDOP) for said GNSS position. Thus, some distance into the building where GPS still works, but works poorly, GPS data may still be used as estimated measurement position with accuracy.

As another example, setting the estimated measurement position and the estimated accuracy of each of a plurality of samples of the estimation labeled type in the training dataset may be done by:
receiving a known position and relative movement data, the relative movement data indicating movement between the known position and the measurement position associated with said sample of the estimation labeled type;
calculating the estimated measurement position and the estimated accuracy to be set for said sample of the estimation labeled type based on the known position and the relative movement data.

Said known position may e.g. be a GPS measurement at an entrance of the building (e.g. in line of sight communication with satellites) where the accuracy of the GPS measurement is so good that it can be taken as ground truth and no accuracy may be needed.

Said relative movement data may be any kind of movement data, relating to movements between the known position and the measurement position associated with said sample, from which the relative relationship between the known position and the measurement position may be calculated. Said relative movement data may comprise inertial measurement data relating to movements between the known position and the measurement position associated with said sample. Inertial measurement data may be data from an accelerometer and/or a gyrator and/or an inertial measurement unit (IMU). Relative movement data may, additionally or alternatively, comprise a heading and a distance, such as a step count, between the known position and the measurement position associated with said sample.

Calculating the estimated measurement position and the estimated accuracy may be done e.g. by dead reckoning, such as pedestrian dead reckoning (PDR).

To exemplify, a mobile phone enters a building. At the entrance it still has a GPS position that may be considered to be ground truth. When entering the building the GPS signal may be lost. However, the mobile phone may still position itself to some extent by dead reckoning based on the last known absolute position at the entrance. At each measurement position the measured RSS signals may be placed in a sample for the training dataset together with an estimate of the measurement position from the dead reckoning and an estimated accuracy from the dead reckoning. Dead reckoning may be subject to cumulative errors. Thus, the more time has passed since the last known position and/or the more times the travelling direction has changed, the worse the accuracy may be. Nevertheless, by including the estimated accuracy in the sample, and thus passing it on to the neural network, the neural network may still be trained on the sample.

It should also be clear that a more accurate estimated measurement position and accuracy could be derived from a combination of an actual estimated position from an IPS like RSS trilateration and a relative estimated position from IMU, often called hybrid systems. There are a number of techniques to combine these two position estimates, for example extended Kalman filter.

### Training the Neural Network

The training of the machine learning model may be configured to modify the machine learning model more strongly for samples of the estimation labeled type that have high estimated accuracy than for samples of the estimation labeled type that have low estimated accuracy.

The term “modify the machine learning model” may in the case of a neural network be construed as modifying weights and/or biases of the neural network. Weights may herein be values associated with connections of the neural network. Biases may herein be values associated with nodes of the neural network. Weights and biases may be randomized before training begins. Each sample in the training dataset may have an impact on how weights and biases change during training but the impact may depend on the estimated accuracy of the sample.

The terms “high” and “low” estimated accuracy should be construed as referring to how accurate the estimated measurement positions are.

As previously mentioned, the estimated accuracy may be represented by the inverse of a standard deviation or the inverse of a variance. In this case a high value of the estimated accuracy should be construed as a high estimated accuracy and the sample should have a strong impact on the modification of the neural network. Alternatively, as previously mentioned, the estimated accuracy may be represented by a standard deviation or variance. In this case a high value of the estimated accuracy should be construed as a low estimated accuracy and the sample should have a weak impact on the modification of the neural network.

The training of the machine learning model may comprise
calculating, by a loss function, a loss, the loss being based on, for at least one sample of the estimation labeled type in the training dataset, a representation of a difference between
   the position converted by the machine learning model from sensor data of said at least one sample; and
   the estimated measurement position of said at least one sample;
modifying the machine learning model based on the loss;
   wherein the loss function is configured to weigh the impact of said representation of said difference on the loss based on the estimated accuracy of said at least one sample, whereby the training modifies the machine learning model more strongly for a high estimated accuracy than for a low estimated accuracy.

For said at least one sample of the estimation labeled type the representation of a difference of the position converted by the neural network and the estimated measurement position may be a mean square error. The mean square error may be the square of the difference of the position converted by the neural network and the estimated measurement position. The mean square error may be weighted by the estimated accuracy. Weighing the impact of said representation of said difference on the loss based on the estimated accuracy may be done by multiplying the representation of said difference, e.g. mean square error, by the estimated accuracy, in the case the estimated accuracy is represented by the inverse of a standard deviation or the inverse of a variance. Alternatively, the representation of said difference may be multiplied by a function of the estimated accuracy, e.g. a linear or non-linear function.

It should be understood that, in addition to samples of the estimation labeled type, the training dataset may further comprise samples of a labeled type, each sample of the labeled type being associated with a geographic position in the environment or in the vicinity of the environment, each sample of the labeled type comprising:
sensor data, measured at the geographic position associated with the sample, the sensor data being characteristic of the geographic position associated with the sample; and
the geographic position associated with the sample;
   wherein the training of the machine learning model is further based on the sensor data and the geographic position of samples of the labeled type in the training dataset.

The geographic position may be a position that may be taken as ground truth, wherein no estimated accuracy is needed. The geographic position may of course be associated with some kind of accuracy, most measurements of a position cannot be expected to be accurate down to the cm level or mm level. Nevertheless, by not including any estimated accuracy in the sample it is signaled to the neural network that the geographic position is true within some acceptable accuracy and can be considered as ground truth.

The sensor data in a labeled sample may be of the same types as in the estimation labeled samples. For example, the sensor data of a sample of the labeled type may comprise distance dependent data, and/or RSS data, and/or UWB distance measurements, and/or light sensor data, and/or audio data.

The sensor data of a sample of the labeled type may be viewed as features for the training of the neural network. The geographic position of a sample of the labeled type may be viewed as a label for the training of the neural network.

Samples of the estimation labeled type may improve the accuracy of the model created by the neural network. They may allow the neural network to mitigate uncertainties in samples of the estimation labeled type.

Samples of the estimation labeled type may e.g. be samples acquired by a mobile phone close to a window of the building where the accuracy of a GPS measurement of the mobile phone is so good that it can be taken as ground truth and no accuracy may be needed. Alternatively, or additionally, samples of the estimation labeled type may be systematically manually created training data. An engineer may e.g. go to the building and manually measure sensor data at a few locations in the building and note down said locations as known geographic positions. By combining estimation labeled samples with labeled samples only a few locations in the building may need to be visited, just to create enough labeled samples to steer the neural network in the right direction. Had only labeled samples been used the engineer may have had to map out the entire building.

It should be understood that, in addition to samples of the estimation labeled type, the training dataset may further comprise samples of an unlabeled type, each sample of the unlabeled type being associated with an unknown measurement position in the environment, each sample of the unlabeled type comprising
sensor data, measured at the unknown measurement position associated with the sample, the sensor data being characteristic of the unknown measurement position associated with the sample;
   wherein the training of the machine learning model is further based on the sensor data of samples of the unlabeled type in the training dataset.

The sensor data in an unlabeled sample may be of the same types as in the estimation labeled samples. For example, the sensor data of a sample of the unlabeled type may comprise distance dependent data, and/or RSS data, and/or UWB distance measurements, and/or light sensor data, and/or audio data.

Each sample of the unlabeled type is associated with an unknown measurement position. Thus, the sample may lack a geographic position and lack an estimated measurement position.

While training a neural network only on samples of the labeled type may be seen as supervised learning, training a neural network only on samples of the unlabeled type may be seen as unsupervised learning. Training a neural network on a training dataset comprising both samples of the labeled type and samples of the unlabeled type may be seen as semi-supervised learning. Semi-supervised learning may be performed e.g. using autoencoders for feature extraction. Samples of the unlabeled type may be abundant and/or easy to acquire, e.g. easier to acquire than samples of the estimation labeled type and samples of the labeled type. Just like a combination of labeled samples and unlabeled samples in semi-supervised learning may provide improvements in learning accuracy, a combination of estimation labeled samples and unlabeled samples may provide improvements in learning accuracy.

### Preprocessing

How the training dataset is composed may be important to the accuracy of the model created by the neural network. In the following a number of examples will be given of how preprocessing of the training dataset may enhance the accuracy of the model created by the neural network.

According to one example, the method may comprise
receiving a candidate training dataset comprising samples of the estimation labeled type;
selecting samples from the candidate dataset to be included in the training dataset, wherein, in at least a sub-environment of the environment, a sample with a high estimated accuracy is selected to be included in the training dataset and a sample with a low estimated accuracy is rejected from being included in the training dataset.

There may be a tradeoff for when low accuracy position estimates give an improvement or instead deteriorates the resulting positioning accuracy of the network. This tradeoff may also look different in various areas of an environment, for example the accuracy can be much higher near entrances than inside a building. For this reason, it may not be straight-forward how to filter away the measurements of too low accuracy without removing too much data in some parts of the environment. One approach may then be to divide the environment into separate sub-environments and study the accuracy of measurements from each sub-environment. If there is an excess of data in one such sub-environment, then the measurements of lowest accuracy may be removed from the dataset.

Selecting samples from the candidate dataset to be included in the training dataset may thus be performed when the number of samples in the candidate dataset in said sub-environment is above a threshold value. If the number of samples in the candidate dataset in said sub-environment is below the threshold value all samples in said sub-environment may be included in the training dataset.

According to another example, the method may comprise
receiving a candidate training dataset comprising samples of the estimation labeled type;
comparing estimated accuracy of samples of the candidate training dataset to a threshold accuracy;
rejecting samples from the candidate training dataset having worse estimated accuracy than the threshold accuracy from being included in the training dataset,
wherein the threshold accuracy has a value between 0 and 30 meters.

For example, the standard deviation of the estimated measurement position may be below a threshold, wherein the threshold has a value between 0 and 30 meters.

Samples with poor estimated accuracy may have little impact on the modification of the neural network, e.g. through the use of weights, that are based on the estimated accuracy, in the loss function. Nevertheless, there may be samples having too poor estimated accuracy to be included in the training dataset. Thus, samples may be rejected according to a threshold accuracy. Further, what constitutes a suitable threshold accuracy may depend on a current quality of the model created by the neural network. For example, the neural network may be trained several times as more samples become available. In a first training a threshold accuracy may be set high, e.g. 30 m, or a threshold accuracy may not be used at all. In subsequent trainings the threshold accuracy may be lowered as the model becomes better. Alternatively, or additionally, the threshold accuracy may be dependent on a size of the candidate training dataset. For a large candidate training dataset a low threshold accuracy (e.g. measured in meters) may be used, and for a small candidate training dataset a high threshold accuracy (e.g. measured in meters) may be used.

According to another example, the method may comprise
augmenting at least one sample of the estimation labeled type, wherein said augmenting comprises:
   introducing noise to sensor data of said at least one sample; and/or
   removing part of the sensor data of said at least one sample; and/or
   introducing an RSS offset to the sensor data of said at least one sample;
including the at least one augmented sample in the training dataset before training the machine learning model.

Augmenting a sample can be likened to introducing additional data into the dataset, without collecting any new measurements, and may therefore help the neural network to generalize better to new measurements.

Through augmentation a sample may be used to form two versions: the original sample and the augmented sample. The training dataset may thus be expanded. Alternatively, only the augmented sample may be included in the training dataset and the original sample may be discarded. Augmented samples in the training dataset may help to reduce overfitting during the training. Further, the model created by training the neural network may be more robust against future changes in the environment.

Noise may be introduced to sensor data by e.g., in the case of RSS data, perturbing RSS fingerprints slightly. For example, if the sensor data of the sample comprises a plurality of RSS signals, a random value may be added to each RSS signal of the plurality. Such augmented samples may make the model for positioning robust against noise.

Part of the sensor data may be removed by e.g., in the case of RSS data, removing one or more RSS signals from a plurality of RSS signals. Thus, the neural network may be trained to handle situations where radio transmitters are turned off or RSS measurements are missed during a scan.

An RSS offset may be introduced to the sensor data by e.g. modifying an RSS signal to simulate all of the radio transmitters, associated with said RSS signal, being attenuated due to receiver or antenna imperfections compared to the reference. Thus, the neural network may be trained to handle situations with differences in radio receivers and radio transmitters or where a surrounding around a radio transmitter changes (e.g. a door to the room of the radio transmitter being opened or closed).

According to a second aspect, there is provided a method for positioning a device within an environment, the method comprising:
acquiring sensor data, measured at the position of the device, the sensor data being characteristic of the position of the device;
accessing a model for positioning within the environment, wherein the model has been created according to the method of the first aspect;
determining the position of the device based on the acquired sensor data and the accessed model.

Thus, a method is provided for determining locations of devices, which method makes use of the model that is generated as discussed above.

The method for positioning a device within an environment may comprise determining a plurality of positions, of the device, along a track, wherein sensor data is acquired for each of the positions along the track, said method further comprising:
determining a first estimate for each position along the track based on the acquired sensor data for each position and the accessed model;
determining estimated relative positions of the positions along the track based on relative movement data, the relative movement data indicating movement between at least two positions along the track;
improving the first estimates for each position along the track using the estimated relative positions.

Thus, the device may be positioned by the model together with relative movement data. The use of relative movement data may improve the accuracy of the positioning. Alternatively, or additionally, the use of relative movement data may mitigate the effect of changes in the environment that are not accounted for in the model. For example, a radio transmitter that has been turned off or moved may cause an error in the positioning. Such an error may, at least partially be corrected by the use of relative movement data.

Relative movement data may comprise inertial measurement data relating to movements between two positions along the track. For example, relative movement data may comprise data from an accelerometer and/or a gyrator and/or an inertial measurement unit, IMU, tracking the movements between two positions along the track. Relative movement data may comprise a heading and a distance, such as a step count, between two positions along the track. The relative movement data may indicate movements between each pair of neighboring positions along the track. However, it should be understood that the relative movement data may not necessarily indicate movements between neighboring positions and not necessarily between all positions of the track. To exemplify, consider a track of 12 positions. Relative movement data may be received for the movements between position 1 and 4, between position 4 and 8, and between position 8 and 12. In another example, relative movement data may be received for the movements between position 1 and 2, between position 5 and 6, and between position 8 to 12.

Determining estimated relative positions of the positions along the track may be performed e.g. using a machine learning model. The estimated relative position of a position may be an estimate of how said position relates to a preceding or succeeding position.

The second aspect may have the same advantages, or similar advantages, as the first aspect encompassed by the claims in this application and may possibly be the subject of a future divisional application.

According to a third aspect, there is provided a method in a device for positioning of the device within an environment, said method comprising:
accessing a positioning model stored on the device, wherein the positioning model is based on training of positioning in the environment and represents characteristics of wireless signals in an area in which the device is located;
acquiring sensor data by one or more sensors of the device, wherein the sensor data comprises position-dependent measurements for one or more positions of the device, wherein each position-dependent measurement relates to a wireless signal transmitted between the device and a radio transmitter arranged in the environment; and
determining a location of the device within the environment based on inputting of the sensor data to the positioning model.

Thus, a method for positioning of a device for determining the location of the device is performed by the device itself. This implies that the device is able to access a positioning model stored on the device for determining the location of the device.

Thanks to the positioning model being stored locally on the device, communication with a remote unit such as a server may be avoided. Such communication may require relatively extensive power consumption. Therefore, the device being able to determine its own location may ensure that communication with a remote unit is avoided and that power consumption is reduced.

In addition, thanks to the positioning of the device being performed by the device itself, it is not required that communication by the device with a remote unit is available for providing positioning of the device. This is particularly advantageous for positioning the device in an environment where communication with a remote unit is not readily available. For instance, the device need not be able to communicate with the remote unit through a computer and/or telecommunication network, such as through Internet. This implies that positioning of the device may be available in an environment being a remote area, where Wi-Fi or mobile Internet is not reliable or available.

The method in the device for positioning of the device is particularly advantageous in cases where the location of the device needs to be determined frequently. In such cases, the low power consumption for determining the location may ensure a long battery time of the device.

The method being provided in the device may also ensure that the location of the device is determined in a fast manner. Since sensor data need not be transmitted to a remote unit, delays related to communication of information is avoided. This is particularly advantageous in cases where the location of the device is used for a real-time application.

The method being provided in the device implies that the method is performed by the device. The method may be performed by the one or more sensors of the device being configured to acquire the sensor data, and by a processing unit being configured to access the positioning model, to receive the sensor data from the one or more sensors and to determine the location of the device.

The environment may be an indoor environment. For instance, the environment for the positioning may be a building, or part of a building. However, it should be understood that the method may also work for outdoor positioning, e.g. outdoor positioning of devices that do not use GPS or similar techniques. The environment may also relate to a complex of multiple buildings and an outdoor area between the buildings.

The positioning model may be a model which may be created as described above. Thus, the positioning model may be the model created using the method of the first aspect. However, it should be realized that the positioning model need not necessarily be such a model. Rather, the positioning model may be a model created in another manner.

The positioning model may be based on training of positioning in the environment. The training may be performed using one or more devices for acquiring information on positioning in the environment. In particular, training of the positioning model need not involve the device that is to be positioned. The positioning model may be determined in a server and may be deployed to the device for use therein.

However, according to an alternative, the training may be performed by the device itself. Thus, the device may be able to first perform training of positioning in the environment and, once the positioning model has been created, the device may use the positioning model for determining the location of the device in the environment. According to yet another alternative, the device may be one of a plurality of devices involved in training of the positioning model.

It should be realized that training may involve gathering a training dataset from the environment. The training dataset may comprise sensor data acquired from the environment in measurement positions and ground truth information providing an indication or estimate of the measurement position. The training dataset may be used for training a machine learning model for forming the positioning model. The training of the machine learning model may involve any manner of using the training dataset for allowing the machine learning model to learn a relationship between sensor data and measurement positions.

The positioning model may thus be a machine learning model formed based on training of positioning in the environment using a training dataset. The positioning model may be an artificial neural network enabling a location of the device to be determined based on sensor data. The artificial neural network may be trained in a manner such that the trained neural network may find data relationships that would be overlooked by humans.

However, the positioning model may not necessarily be an artificial neural network but may rather be another kind of model for relating sensor data to positions in the environment. The model is based on training using a training dataset but the relation between sensor data and position formed by the model may be based on any statistical model. For instance, the positioning model may be, e.g., a decision tree, a model based on decision trees such as a random forest, a support vector machine, a Bayesian network, or a k-nearest neighbor algorithm.

The positioning model represents characteristics of wireless signals. Thus, the positioning model may enable a measurement relating to wireless signals in the environment to be converted to a location of the device.

The characteristics of wireless signals may relate to characteristics of signals transmitted between a radio transmitter and a device located in the environment. The characteristics of the wireless signals may for instance comprise a signal strength in a measurement position within the environment of a wireless signal transmitted by the radio transmitter. The characteristics of the wireless signals may also or alternatively comprise an indication of a time of travel of the wireless signal between the radio transmitter and the device.

The characteristics of the wireless signals may be different for different positions in the environment in which the characteristics are measured. This may be due to difference in distance between the radio transmitter and the position and also based on difference in signal propagation characteristics in the area between the radio transmitter and the position, such as presence or absence of walls.

The positioning model may directly represent characteristics of the wireless signals in respective positions in an area in the environment. However, the positioning model may also or alternatively represent characteristics of signal propagation in an area in the environment for allowing determining positions in the area.

The positioning model may be accessed in any suitable manner. For instance, the positioning model may be retrieved from a memory on the device for enabling the positioning model to be used for determining the location of the device. Alternatively, the positioning model may be accessed by making a function call to the positioning model.

The sensor data may be data acquired for one or more positions of the device. The sensor data may comprise position-dependent measurement for the position(s). The position-dependent measurement may provide information of wireless signal transmitted between the device and the radio transmitter. The information may provide any type of indication that is dependent on the position of the device.

The sensor data is characteristic of the position of the device. Such sensor data may be any kind of sensor data that changes with the position. The sensor data may be characteristic of the position by indicating that the position belongs to a subset of positions within the environment. For example, the sensor data may be characteristic of the position by indicating that the position is at a certain distance from a radio transmitter. In this example all positions at said distance from the radio transmitter may be seen as belonging to the subset of positions. The sensor data may comprise distance dependent data.

For instance, the sensor data may provide an indication of distance to the radio transmitter. The sensor data may provide an indication of a characteristic of the wireless signal that is representative of the position of the device.

The indication of the distance may not necessarily be a direct measure of the distance. Rather, the indication of the distance may be a quantity that is dependent on distance in some way. The measured quantity need not even be directly proportional to the distance and may even be non-linearly related to the distance.

The position-dependent measurement may thus be a distance measurement based on a received signal strength (RSS), e.g. a received power of a signal, or be based on a time of travel of a signal between a source and a receiving unit. Also, the distance dependent data may be represented in a non-linear scale, such as a logarithmic scale.

The sensor data may comprise position-dependent measurements based on more than one wireless signal transmitted between the device and more than one radio transmitter. For instance, a time of arrival of wireless signals from at least two radio transmitters may be sensed and compared for providing position-dependent measurements. According to an example, a downlink time difference of arrival (DL-TDOA) may be used, wherein a time of arrival of signals from different radio transmitters are compared.

In one example, sensor data may comprise distance dependent measurements like round trip time, RTT, to WiFi APs. Distance-dependent measurements may also or alternatively be acquired by round trip time to base stations, such as multi-cell round trip time (MC-RTT). RTT may be the time it takes for a network request to go from a device to a WiFi AP and back again. In another example, sensor data may comprise UWB distance measurements to UWB beacons. In another example, sensor data may comprise light sensor data, e.g. light sensor data of a modulated light fingerprint. Light, e.g. invisible light, may be modulated in different ways in different locations of a building and thereby form a fingerprint of the location. Similarly, sensor data may comprise audio data. Sound, e.g. sound not perceivable by humans, may be modulated in different ways in different locations of a building and thereby form a fingerprint of the location. Sensor data may, additionally or alternatively, comprise data from pressure sensors which indicates height.

It should also be clear that sensor data does not necessarily have to be an absolute value. Sensor data could be a relative value measurement, for example pressure difference compared to walking into a building, RSS difference measured relative to strongest RSS value measured at the location, and so on.

Sensor data may comprise one or more entities of data. For example, sensor data may comprise one RSS measurement to one single radio transmitter. In another example, sensor data may comprise a plurality of RSS measurements, wherein each RSS measurement corresponds to a separate radio transmitter. Such a plurality of RSS measurements may be seen as a fingerprint of a location.

Sensor data may comprise one type of sensor data, e.g. only RSS data, or any combination of types of sensor data, e.g. a combination of RSS data and RTT data, or a combination of RSS data, light sensor data, and audio data. Just like combinations of several entities of sensor data, sensor data of the same type may be seen as a fingerprint of a location, combinations of sensor data of different types may be seen as a fingerprint of a location.

The sensors of the device may be any type of suitable sensor for acquiring the sensor data. In particular, the device may comprise a radio transceiver which may be used for acquiring sensor data relating to wireless signals transmitted between the device and the radio transmitter, such as RSS data and/or RTT data.

According to an embodiment, the position-dependent measurements comprises at least one of: a received signal strength from the radio transmitter, a time measurement representing a duration of transmission of the wireless signal between the device and one or more radio transmitters, or an angular measurement of the device in relation to the radio transmitter.

These are position-dependent measurements that may be suitable for determining the location of the device. These types of position-dependent measurements may be readily available in the device.

The position-dependent measurements may further comprise measurement information in relation to a plurality of radio transmitters. Thus, the position-dependent measurement for one position of the device may comprise a plurality of measurements comprising at least one measurement in relation to each of a plurality of radio transmitters. The measurement in relation to each of the plurality of radio transmitters may be at least one of: a received signal strength from the radio transmitter, a time measurement representing a duration of transmission of the wireless signal between the device and the radio transmitter, or an angular measurement of the device in relation to the radio transmitter.

The received signal strength may for instance be in form of RSS data or reference signal received power (RSRP) data. The time measurement representing a duration of transmission of the wireless signal between the device and the radio transmitter may for instance be in form of RTT data or time of arrival (ToA) data, such as DL-TDoA data relating time of arrival of signals from more than one radio transmitter, or MC-RTT data. The angular measurement of the device in relation to the radio transmitter may for instance be in form of angle of arrival (AoA) data.

According to another embodiment, the position-dependent measurements may comprise a channel impulse response (CIR), which may provide additional information on a channel between the device and the radio transmitter, including information on line-of-sight components and non-line-of-sight components.

According to an embodiment, the positioning model is a neural network model or a k-nearest neighbor model.

These may be suitable models for providing accurate determination of the location of the device.

The training of the neural network model may require relatively extensive computer resources and may therefore advantageously be performed in a server which receives training data from one or more devices. The neural network model may thus be transferred to the positioning model once the neural network model has been trained in the server.

The training of the k-nearest neighbor (KNN) model may require less extensive computer resources compared to training of the neural network model. Thus, the KNN model may be trained on the device that is later to be positioned in the environment. However, it should also be realized that the KNN model may be trained in a server which receives training data from one or more devices.

The KNN model may be a weighted nearest neighbor model. The neighbors used in the weighted nearest neighbor model may thus be given different weights.

According to an embodiment, the method further comprises:
receiving the positioning model from a server, and
storing the positioning model on the device.

This implies that the positioning model may be determined centrally.

This facilitates use of training data from a plurality of devices for training the positioning model.

The positioning model may be received by the device from a server. The server may be arranged in any location and may be configured to communicate with the device in any suitable manner, such as through a computer and/or telecommunication network.

It should be realized that the positioning model may be received by the device at any suitable moment. The device may for instance receive the positioning model when the device is close to the environment or when the device enters the environment. Thus, the positioning model may be received at a moment when it is determined that the positioning model may be needed by the device.

However, according to an alternative, the positioning model may be received based on a request from the device or when it is anticipated that the positioning model may be needed. Thus, the positioning model need not be received in connection to a time when it is to be used. This may facilitate allowing the positioning model to be received at an appropriate point in time, e.g., when the device is connected to an external power supply, or when the device is connected to Wi-Fi.

According to an embodiment, the method further comprises requesting an update of the positioning model from the server; receiving an updated positioning model and replacing the positioning model stored on the device by the updated positioning model, wherein requesting of the update of the positioning model is triggered by an updating condition.

Thanks to updating of the positioning model, the device may have a latest version of the positioning model for positioning of the device in the environment.

The positioning model may be continuously improved through updated training. Such updating may suitably be performed on a server that may receive training data for updating the positioning model from a plurality of devices. For instance, updating of the positioning model may ensure that changes to radio transmitters in the environment are taken into account in the positioning model, such as changes relating to adding or removing of a radio transmitter or changing a position of a radio transmitter.

The update of the positioning model may requested at a suitable time corresponding to the updating condition. The updating condition may thus be a condition defining a suitable point in time for updating the positioning model in the device.

The updating condition may for instance relate to a condition that indicates suitability of the device communicating with the server. Thus, the updating condition may correspond to the device being connected to an external power supply, or the device being connected to a suitable relay for communication with the server, such as connected to Wi-Fi.

The updating condition may also or alternatively relate to a condition indicating a need for an update. Thus, the updating condition may correspond to a duration since a previous update of the positioning model being performed.

It should be further realized that a plurality of updating conditions may be used. The triggering of the requesting of the update of the positioning model may require that one of the updating conditions is met or may require that more than one of the plurality of updating conditions is met.

According to an embodiment, a plurality of positioning models representing different areas are stored on the device, and wherein accessing the positioning model comprises selecting the positioning model among the plurality of positioning models based on position information of the device.

The device may thus be configured to provide positioning in different areas using locally stored positioning models. Each positioning model may correspond to a specific area or environment. For instance, each positioning model may relate to a respective indoor environment, such as a respective building.

The device may be configured to determine a condition for selecting an appropriate positioning model among the plurality of positioning models. The device may for instance be configured to determine position information that may be used for selecting the positioning model.

The position information for selecting the positioning model may be position information that is available when the positioning model is to be selected. For instance, the position information may be a GPS position which may be available to the device when entering a building.

Thanks to having a plurality of positioning models stored on the device, the device may be able to provide positioning in several separate areas, such as in several different indoor environments, such as different buildings. The device may for instance be configured to store positioning models relating to indoor environments that are frequently visited by the device.

The positioning model may correspond to a specific area in the environment. For instance, the positioning model may represent one or more buildings. However, the positioning model may alternatively represent an area defined by particular coordinates, such that the positioning model may for example represent an area of 100×100 m or 1000×1000 m.

The positioning model may be selected based on which cell is a serving cell to the device. Thus, positioning models may be associated with cells to allow selection of the positioning model based on the cell becoming the serving cell. The positioning model may alternatively be selected based on which Long Range Wide Area Network (LoRa WAN) gateway the device is connected to.

According to an embodiment, wherein a plurality of positioning models are stored on the device, the method further comprises determining a plurality of candidate locations, wherein each candidate location is determined based on inputting of the sensor data to a respective one of the plurality of positioning models, and wherein the determining of the location is based on the candidate locations.

Thus, the device need not necessarily select a positioning model based on position information. Rather, the device may use the plurality of positioning models such that the location of the device may be determined in an accurate manner.

Thus, the device may select positioning models from the plurality of positioning models for determining candidate locations based on the selected positioning models. Each of the selected positioning models may be used for determining a candidate location by the selected positioning models receiving the sensor data.

The selected positioning models may then generate multiple estimated candidate locations, one candidate location from each selected positioning model. The device may then select which candidate location to use as a final estimated location of the device based on, e.g., information outputted from the positioning models, positioning information, or historical information.

For instance, if the output from the positioning models includes an estimated accuracy of the candidate location, the device may select the candidate location with lowest estimated accuracy as the final estimated location of the device. Alternatively, the device may select the candidate location being most consistent with historical positioning estimates, e.g., the candidate location closest to a most recent estimated location of the device.

It should further be realized that the device may determine the final estimated location by combining the candidate locations, such as determining a location based on an average from a plurality of candidate locations, such as a center location between a number of candidate locations associated with best estimated accuracies.

According to an embodiment, the method further comprises removing one or more positioning models from the plurality of positioning models stored on the device based on a removing condition.

The positioning models may require storage space on the device. Thus, in order for the device to have sufficient storage capacity, unneeded positioning models may be removed.

The removing condition may for instance be related to an age of the positioning model, a frequency of use of the positioning model, or an available storage capacity of the device, such that the number of positioning models stored may be reduced.

According to an embodiment, the method further comprises acquiring additional sensor data, such as accelerometer data, gyroscope data, magnetometer data, step counter data and/or pressure sensor data, wherein the determining the location of the device is further based on the additional sensor data.

The additional sensor data may provide additional information for accurately determining the location of the device. Thus, the additional sensor data may provide information that may supplement information relating to wireless signals for positioning of the device.

The use of additional sensor data in positioning of the device is particularly facilitated by the positioning of the device being performed in the device itself. Thus, the additional sensor data need not be communicated to a remote unit for positioning of the device. This may ensure that additional sensor data may be used without requiring extensive communication of information between the device and the remote unit.

The additional sensor data may be sensor data that may be available on the device. For instance, the additional sensor data may be sensor data that may be acquired by sensors that are available on the device to be positioned, such as on a mobile phone. It should be realized that accelerometer data, gyroscope data, magnetometer data, step counter data and/or pressure sensor data may be readily available on the device, such as on a mobile phone.

According to an embodiment, the additional sensor data is input to the positioning model and/or wherein the determining the location of the device comprises combining an output from the positioning model with the additional sensor data.

Thus, the additional sensor data may be used in the positioning model. This may for instance be used by the positioning model being a neural network model that may accept the additional sensor data as input for determining the location of the device. Thus, the positioning model may be trained on allowing additional sensor data to be used for improving determining of the location of the device.

However, the additional sensor data may also or alternatively be combined with output from the positioning model. Thus, the positioning model may provide a determination of the location of the device. This determination may be improved by using the additional sensor data.

The combining of the output from the positioning model with the additional sensor data may apply weighting for accurately determining the location of the device.

According to an embodiment, determining the location of the device comprises determining a sequence of locations of the device using a filter, such as a Kalman filter or a particle filter, for taking previous locations in the sequence into account in determining a current location of the device.

Each of the locations in the sequence of locations may be determined based on inputting of sensor data to the positioning model. Thus, the determination of a plurality of locations by the positioning model may be used for ensuring an accurate determination of each of the locations.

The determining of the location may thus use previous locations for determining the current location. Also, the determining of a current location may be used for re-evaluating previous locations. Thus, previous locations may also be updated based on the determined current location and such updating may in turn also affect the determining of the current location. Hence, the sensor data relating to a plurality of positions may be used in combination for accurately determining each of the locations of the device in a sequence.

The determining of a plurality of locations may use sensor fusion for combining the plurality of locations being determined. The sensor fusion ensures that information of the respective locations may be determined with less uncertainty compared to the individual determination of the locations. The sensor fusion may be provided using a filter, such as a Kalman filter or a particle filter.

It should be further realized that sensor fusion may also or alternatively be applied for combining additional sensor data with output from the positioning model. In this case, the sensor fusion may combine information of individual determinations of a single location to provide an improved accuracy of the location. However, the sensor fusion using additional sensor data may also or alternatively apply the sensor fusion for combining information relating to a plurality of locations in a sequence.

According to an embodiment, the positioning model represents characteristics of wireless signals in one or more buildings in the area.

The positioning model may suitably be used for positioning of the device in an indoor environment, such as a building.

Thanks to the positioning model representing characteristics in a building, the device may be configured to activate the positioning model when the device enters the building. This may ensure that the device may be appropriately positioned and may seamlessly shift from GPS positioning to indoor positioning using the positioning model.

According to an embodiment, the positioning model comprises mapping information of the one or more buildings, wherein the determining the location of the device is further based on information of structures, such as walls, in the mapping information.

Thus, the positioning model may provide further information of the environment that may be useful for correctly determining the location of the device.

The mapping information may be used for determining a realistic location of the device. For instance, the mapping information may be used for ensuring that a sequence of locations of the device does not correspond to the device moving through a wall in the building. The mapping information may also be used for modelling propagation of wireless signals within the building, as propagation of the wireless signals is for instance dependent on whether the wireless signal passes through a wall in the building.

According to an embodiment, the method is used for one or more of: positioning of the device, determining a relation of the location of the device to a geofence, or tracking of the device along a sequence of locations.

The method may thus be used in an application where a location of the device needs to be determined. In particular, the method may be used in an application, wherein real-time information of the location of the device may be needed.

The method is particularly useful in a real-time application, such as when the device is used for navigation, since the location of the device may be determined in a fast manner thanks to the method not requiring any communication with a remote unit, which may cause a delay by the transmission of signals between the device and the remote unit.

In addition, a real-time application may require frequent updates of the location of the device. Thanks to the method providing determining of the location of the device using a low power consumption, the method is suited for performing frequent determinations of the location of device.

The device may be provided with a geofence associating a function with a particular region in the environment. For instance, the device may be configured to activate or deactivate an application on the device in dependence of the device being within the region defined by the geofence. Also or alternatively, the device may be configured to trigger a function in dependence of the device entering or leaving the region defined by the geofence, such as the device being configured to send a message to another device based on the device leaving the region defined by the geofence.

The method may provide tracking of the location of the device. This may be used for continuously determining the location of the device and to follow movements of the device through the environment.

According to a fourth aspect, there is provided a computer program product comprising computer-readable instructions which, when executed on a processing unit, will cause a processing unit to perform the method according to the third aspect.

Effects and features of this fourth aspect are largely analogous to those described above in connection with the third aspect. Embodiments mentioned in relation to the third aspect are largely compatible with the fourth aspect.

The computer program product may thus provide computer-readable instructions for allowing the method to be implemented. This allows the functionality of the method to be provided to any processing unit.

The computer program product may comprise a non-transient computer-readable medium for carrying the computer-readable instructions.

Alternatively, the computer program product may comprise a signal carrying the computer-readable instructions, e.g., for communicating the computer program product to the processing unit through wired or wireless communication.

According to a fifth aspect, there is provided a device, comprising:
a memory storing a positioning model, wherein the positioning model is based on training of positioning in an environment and represents characteristics of wireless signals in an area in the environment;
a sensor configured to acquire sensor data, wherein the sensor data comprises position-dependent measurements for one or more positions of the device, wherein each position-dependent measurement relates to a wireless signal transmitted between the device and a radio transmitter arranged in the environment; and
a processing unit configured to access the positioning model, receive the sensor data, and determine a location of the device within the environment based on inputting of the sensor data to the positioning model.

Effects and features of this fifth aspect are largely analogous to those described above in connection with the third and fourth aspects. Embodiments mentioned in relation to the third and fourth aspects are largely compatible with the fifth aspect.

The device may thus be configured to determine its own location in the environment. The device may typically be a movable device, such as a mobile phone, that may be moved within the environment.

Thanks to the positioning model being stored locally on the device, communication by the device with a remote unit such as a server may be avoided. Such communication may require relatively extensive power consumption. Therefore, the device being able to determine its own location may ensure that communication with a remote unit is avoided and that power consumption of the device is reduced.

Also, the device may be able to determine the location in a fast manner, as delays associated with communication with a remote unit may be avoided.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1a illustrates a flowchart of a method for creating a model for positioning within an environment.

FIG. 1b illustrates a flowchart of a method for training a machine learning model.

FIG. 1c is a schematic illustration of a dataset.

FIG. 1d illustrates a flowchart of a method for creating a model for positioning within an environment.

FIG. 2 illustrates a flowchart of a method for creating a model for positioning within an environment.

FIG. 3 illustrates a flowchart of a method for creating a model for positioning within an environment.

FIG. 4 illustrates a flowchart of a method for positioning within an environment.

FIG. 5 illustrates a flowchart of a method for positioning within an environment.

FIG. 6 illustrates a neural network.

FIG. 7 illustrates positioning.

FIG. 8 illustrates positioning.

FIG. 9 is a schematic view of a device configured to determine its location within an environment.

### DETAILED DESCRIPTION

In cooperation with attached drawings, the technical contents and detailed description of the present invention are described hereinafter according to preferable embodiments, being not used to limit the claimed scope. This invention may be embodied in many different forms and should not be construed as limited to the embodiments set forth herein; rather, these embodiments are provided for thoroughness and completeness, and fully convey the scope of the invention to the skilled person.

As an example of a possible implementation of our invention, we here describe an artificial neural network based positioning solution being trained by estimated positions in a building with corresponding estimated accuracies and received signal strength (RSS) as sensor values. It should be clear that there are a number of different implementation alternatives; different neural network architectures, many different sensor types that can be combined in multiple ways, many positioning estimation techniques and many ways of estimating positioning accuracy that are all covered in the intention and scope of this patent.

Assume a delimited 3D environment (or 2D in the case of single floor/ground environments), where the first two dimensions correspond to latitude and longitude, and the third dimension is the altitude or floor. The environment here is assumed to be mostly indoor, but could be outdoor or a combination of the two. From this environment, sensor data 12, in this example received signal strength (RSS) data from radio receivers, are measured by one or multiple devices at different locations within the environment. The signal, whose signal strength is measured, may for example originate from Wi-Fi and Bluetooth beacons, iBeacons, etc. By use of these measurements alone, or in combination with other sensor data such as inertial sensors, the measurement positions may be estimated.

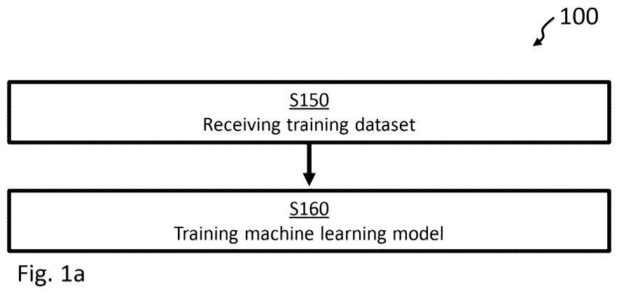

FIG. 1c is a schematic illustration of a dataset to be used for creating the model for positioning within an environment. The dataset comprises samples 10 of the estimation labeled type. The data is divided into a training dataset 1 and a validation dataset 2. The figure illustrates measurements at M measurement positions in the environment that have been gathered during a collection phase, where N unique sources of sensor data 12, in this case RSS data, were detected in total. Let R be an M×N matrix containing a collection of the RSS data, each column corresponding to a specific source of RSS data, i.e. a specific radio transmitter. It should be noted that all radio transmitters may not be detectable at any given measurement position, undetected radio transmitters may be assigned a value corresponding to the lowest possible signal strength for the type of radio transmitter or be assigned a NaN (Not a Number) value. Then, let Y be an M×3 matrix (or M×2 in the 2D setting) containing the 3D estimated measurement positions 14 for the M measurements, and let A be a M×3 matrix (or M×2 in the 2D setting) comprising estimated accuracies 16 of these estimated measurement positions 14. The estimated accuracy may comprise an accuracy value for each separate dimension, as illustrated by aₓ, a_{y}, and a_{z} in matrix A in FIG. 1c. Alternatively, the estimated accuracy may comprise an accuracy value that relates to more than one dimension. For example, matrix A in FIG. 1c could comprise accuracy values a_{xy}, and a_{z}, wherein the estimated accuracy in both the x-dimension and the y-dimension is a_{xy}. The third dimension in Y can be either estimates of the floor or the altitude. The matrices R, Y, and A will be referred to as a dataset, which is related to one specific 3D environment. The number of sensor measurements M and number of detected signal sources N can be any numbers, but in general the larger the dataset, the better the possibilities are of accurate positioning.

The illustrated dataset is divided into subsets for training and validation and/or testing, i.e. into a training dataset 1, a validation dataset 2 and/or a test dataset 3. The training dataset 1 is used to train a machine learning model 20, whereby the model for positioning within the environment is created. In the following the machine learning model 20 will be exemplified by a neural network 20. The validation dataset 2 can be used to determine when the model is of sufficient quality, and tune parameters of the neural network 20, and the test dataset 3 can be used to get a measure of the final performance of the model. When training a neural network 20 and using the validation dataset 2 to determine when to terminate the training, the evaluation can for consistency use the corresponding estimated accuracies 16 as weights as well. Another approach may be to choose a few samples 10 with high estimated accuracy 16 to use for evaluation. While the model may be created using only the training dataset 1, a validation dataset 2 and/or a test dataset 3 may be important for evaluating the resulting model and training progress.

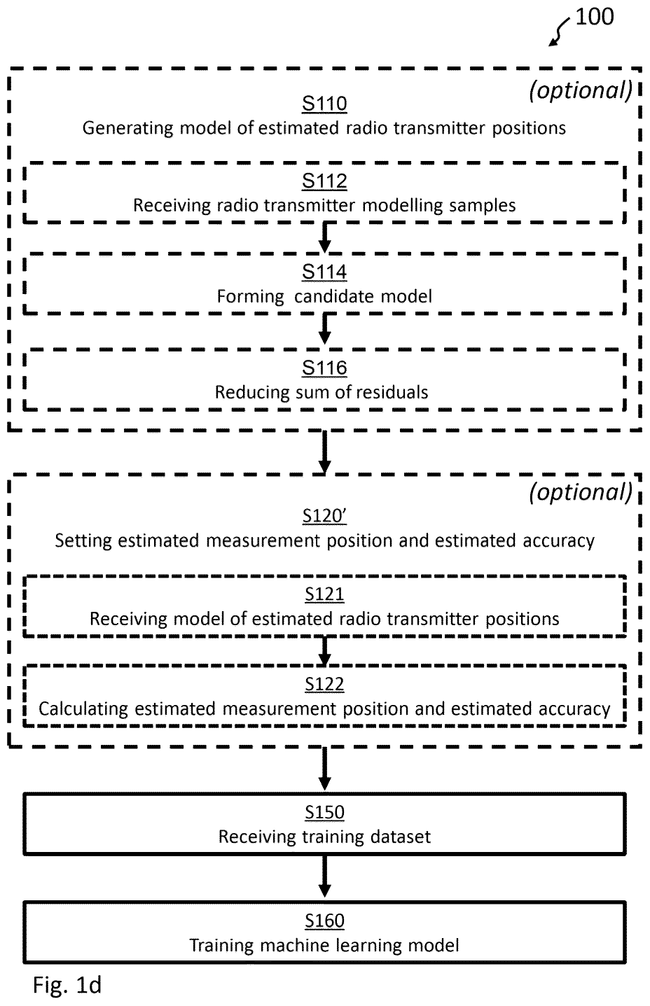

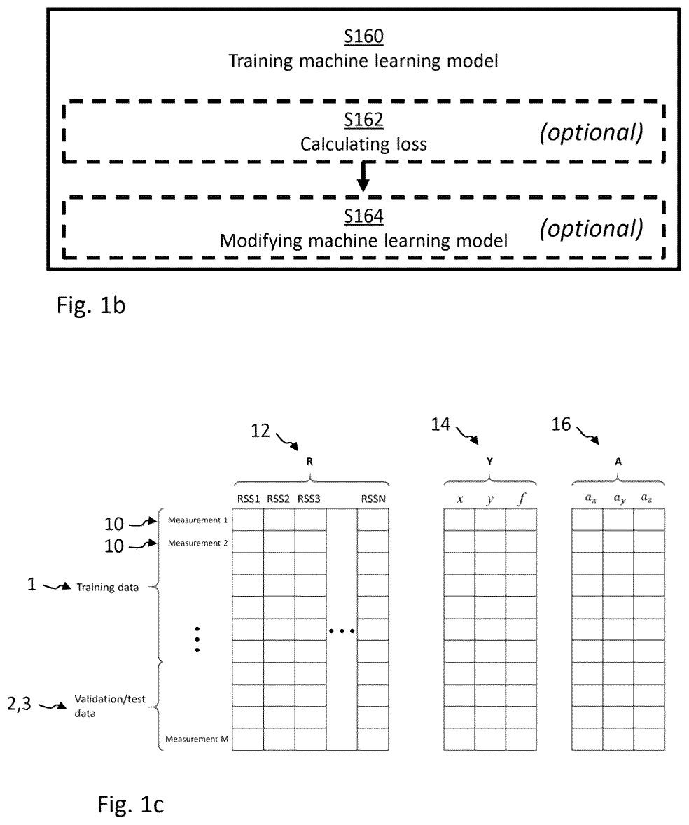

FIG. 1a illustrates a flowchart of a method 100 for creating a model for positioning within an environment. The method 100 is herein described as comprising the steps S150 and S160. However, it should be understood that the method 100 may comprise some optional steps, as indicated in the FIG. 1d. It should be understood that at least some of the steps may be performed in a different order than indicated in the figures, as readily understood by the skilled person. Alternative, or additional, steps in performing the method 100 are illustrated in FIGS. 2 and 3. All figures comprise the steps of receiving S150 the training dataset 1 and training S160 the neural network 20. FIGS. 1d and 2 elaborate on different ways of setting S120 the estimated measurement positions 14 and estimated accuracies 16 for the samples 10. FIG. 3 elaborate on different ways of preprocessing data to be included in the training dataset 10. The methods 100 illustrated in FIG. 1-3 may be performed on a computing unit, e.g. on a server.

In the following, the steps of receiving S150 the training dataset 10 and training S160 the neural network 20 will be described. The other optional steps will be described later.

The received S150 training dataset 10 may be a training dataset 10 as described in conjunction with FIG. 1c. The sensor data 12 of the samples 10 of the training dataset 10 (in matrix R) may comprise RSS data (as illustrated in FIG. 1c) and/or UWB distance measurements, and/or light sensor data, and/or audio data, and/or any kind of distance dependent data. The estimated measurement positions 14 (in matrix Y) and the estimated accuracies 16 (in matrix A) of the samples 10 of the training dataset 10 may be created or set in various ways, as discussed below. For now, let us just assume that they have already been created/set.

The neural network 20 is trained S160 to convert sensor data 12 to a position in the environment, wherein the training S160 is based on the samples 10 of the estimation labeled type in the training dataset 1. There are multiple architectures possible for use in this neural network 20, for example autoencoders, long short-term memory (LSTM)-units, or multi-layer perceptrons.

The training S160 of the neural network 20 may be configured to modify the neural network 20 more strongly for samples 10 of the estimation labeled type that have high estimated accuracy (accuracy figure in meters is low) 16 than for samples 10 of the estimation labeled type that have low estimated accuracy 16 (accuracy figure in meters is high). Accordingly, the neural network 20 may be trained using batches of R as input, wherein the loss function in the training S160 is a measure of the positioning error, weighted by the accuracy. This means that measurements with a high accuracy may have a higher impact on the model training than low-accuracy measurements. Accordingly, the training S160 may e.g. comprise, as illustrated in FIG. 1b calculating S162 a loss, and modifying S164 the neural network 20 based on the loss.

One possible neural network architecture that deals with the situation of having continuous estimates of latitude [x] and longitude [y], but discrete values for the altitude, i.e. floor [f], is presented here. This network consists of two multi-layer perceptrons (MLPs) that are trained simultaneously. Let the positioning MLP be called Eₚ, the floor classification MLP E_{f}. An input matrix R of sensor data 12 to the neural network 20 results in two outputs

$$E ( R ) = [ \hat{x} , \hat{y} ] and {E}_{f} ( R ) = \hat{f} ,$$

where [\hat{x}, ŷ, \hat{f}] is the 3D position output of the neural network 20. The loss function used to train the neural network 20 for one sample 10 may then be given by

$$L ( \hat{x} , \hat{y} , \hat{f} ; x , y , f ) = {{a}_{x} ( x - \hat{x} )}^{2} + {{a}_{y} ( y - \hat{y} )}^{2} - {a}_{f} Clog ( P ( f \vert \hat{f} ) ) ,$$

where C is a constant, a=[aₓ, a_{y}, a_{f}] is the estimated accuracy 16 of this estimated measurement position 14 [x, y, f]. The estimated accuracy may herein be the inverse of the standard deviation, or variance, of errors of estimated measurement positions 14.

$$P ( f \vert \hat{f} ) =$$

$$σ ( {q}_{0} - \hat{f} ) , if f = 0 ,$$

$$σ ( {q}_{k} - \hat{f} ) - σ ( {q}_{k - 1} - \hat{f} ) , if 0 < f < {n}_{f} ,$$

$$1 - σ ( {q}_{{n}_{f} - 1} - \hat{f} ) , if f = {n}_{f} ,$$

where n_{f} is the number of floors, σ is the sigmoid function, and qₖ=k/n_{f}. The neural network 20 may be trained using common neural network techniques such as augmentations, dropout, batch-normalization, etc. A few possible augmentations useful for measurements of RSS are dropping beacons, adding an offset, and adding noise to the measurements. This can be likened to introducing additional data into the dataset, without collecting any new measurements, and it therefore helps the network to generalize better to new measurements.

If the altitude is a continuous value [z] the loss function can instead be for example

$$L ( \hat{x} , \hat{y} , \hat{z} ; x , y , z ) = {{a}_{x} ( x - \hat{x} )}^{2} + {{a}_{y} ( y - \hat{y} )}^{2} - {{a}_{z} ( z - \hat{z} )}^{2} ,$$

and if the accuracy is estimated for the complete position estimate, rather than for each component separately, the weighting of the loss function may be

$$L ( \hat{x} , \hat{y} , \hat{z} ; x , y , z ) = a ( {( x - \hat{x} )}^{2} + {( y - \hat{y} )}^{2} - {( z - \hat{z} )}^{2} ) ,$$

where a is a measure of the accuracy for all components of the position estimate.

In the above examples (x-\hat{x}) represents a difference (in the one of the three dimensions) between the position (\hat{x} for said one dimension) converted by the neural network 20 from sensor data 12 (in this case R); and the estimated measurement position (x for said one dimension). When the loss is calculated S162 in the above examples the loss function is configured to weigh the impact of said difference on the loss based on the estimated accuracy 16. The weighing is herein done by multiplying said difference with the corresponding estimated accuracy 16. In the above examples the loss is calculated for one sample 10 alone. It should be understood that the training S160 may be performed as batch training, wherein a number of samples may be processed in one batch before the neural network 20 is modified S164, i.e. before the neural network 20 is updated. The loss may be calculated S162 for the entire batch, e.g. by summing the losses associated with the individual samples 10.

After calculating S162 the loss, the neural network 20 may be modified S164. Weights and/or biases of the neural network 20 may be modified S164. Weights may herein be values associated with connections of the neural network 20. Biases may herein be values associated with nodes of the neural network 20. Weights and biases may be randomized before training S160 begins.

In the above examples the neural network 20 has been configured to output a position. The neural network 20 may additionally be configured to output a measure of the accuracy. This may be useful during online positioning. The above neural network can for this purpose be altered to estimate a probability distribution of the position instead of just the actual position. Since the floor-estimate above results in a probability for each floor, this variable already has an estimate of the accuracy. The output of the positioning neural network may, on the other hand, be altered to be [ûₓ, ôₓ, û_{y}, ô_{y}] instead of [x, y]. It is assumed that

$$P ( x , y \vert {μ}_{x} , {σ}_{x} , {μ}_{y} , {σ}_{y} ) = \frac{1}{2 {πσ}_{x} {σ}_{y}} exp ( \frac{{( x - {μ}_{x} )}^{2}}{{σ}_{x}^{2}} + \frac{{( y - {μ}_{y} )}^{2}}{{σ}_{{y}^{2}}} ) ,$$

which results in the loss function

$$L ( {\hat{μ}}_{x} , {\hat{σ}}_{x} , {\hat{μ}}_{y} , {\hat{σ}}_{y} , \hat{f} ; x , y , f ) = - \sqrt{{a}_{x}^{2} + {a}_{y}^{2}} log ( P ( x , y \vert {\hat{μ}}_{x} , {\hat{σ}}_{x} , {\hat{μ}}_{y} , {\hat{σ}}_{y} ) ) - {a}_{f} Clog ( P ( f \vert \hat{f} ) ) ,$$

for the original problem formulation. It can be shown that this neural network architecture can produce estimates of the magnitude of positioning errors for new measurements that are correlated to the true errors.

FIGS. 1d and 2 illustrate three different ways of setting S120′, S120″, S120″ the estimated measurement positions 14 and estimated accuracies 16 for the samples 10. The flowchart of FIG. 2 illustrates a combination of two different ways of performing setting step S120″, S120″. However, it should be understood that any of the three ways S120′, S120″, S120″ may be used on its own or in combination with any one of the other ways of setting S120′, S120″, S120″. For example, for one subset of samples 10 of the training dataset 1 the estimated measurement positions 14 and estimated accuracies 16 may be set using S120′ while for another subset of samples 10 of the training dataset 1 the estimated measurement positions 14 and estimated accuracies 16 may be set using S120″.

In FIG. 1d setting S120′ the estimated measurement position 14 and the estimated accuracy 16 of a sample 10 of the estimation labeled type in the training dataset 1 is performed by:
receiving S121 a model of estimated radio transmitter positions in the environment; and
calculating S122 the estimated measurement position 14 and the estimated accuracy 16 to be set for said sample 10 of the estimation labeled type based on distance dependent measurements to the transmitters and the model of estimated radio transmitter positions.

For example, RSS measurements of the sample may indicate distances to a number of radio transmitters whose estimated positions can be found in the model. By trilateration, the estimated measurement position of the sample and the estimated accuracy may be found. Alternatively, an estimated measurement position may be guessed and then iteratively improved by iterative reduction of residuals.

As further illustrated in FIG. 1d the model of estimated radio transmitter positions may be generated S110 by:
receiving S112 radio transmitter modelling samples comprising distance dependent data;
forming S114 a candidate model of estimated radio transmitter positions and estimated measurement positions 14 of the radio transmitter modelling samples based on the received radio transmitter modelling samples and a plurality of defined positions for samples and/or for radio transmitters; and
iteratively reducing S116 a sum of residuals for said candidate model.

The received S112 radio transmitter modelling samples may comprise RSS data. The received S112 radio transmitter modelling samples may be a matrix similar to R, described in conjunction with FIG. 1. When the model of estimated radio transmitter positions is generated this way we call it generating the model by bundle optimization.

The candidate model may be formed S114 by e.g. guessing estimated radio transmitter positions and estimated measurement positions 14 of the radio transmitter modelling samples. Alternatively, the candidate model may be based on an old model.

In addition to the received radio transmitter modelling samples there may be a plurality of defined positions for samples and/or for radio transmitters. For example, some of the radio transmitter modelling samples may be samples of a labeled type and thereby be associated with a geographic position. In another example, the position of some of the radio transmitters may be known. Such defined positions may be included in the candidate model. The candidate model may then comprise e.g. a number of estimated measurement positions 14 of the radio transmitter modelling samples, a number of estimated radio transmitter positions, and a number of known radio transmitter positions (and/or a number of known measurement positions).

For each radio transmitter modelling sample, a difference may be calculated, the difference may be a difference between
an estimated distance between the measurement position of said sample and a radio transmitter as represented by the model; and
a measured distance between the measurement position of said at least one sample and the radio transmitter as represented by the distance dependent data. Said difference may represent a residual. This may be repeated for all samples and all radio transmitters such that a sum of residuals may be formed. When a position is known, e.g. a measurement position or a radio transmitter position is known, the known position is used instead of an estimated one. The sum of residuals may then represent how far off the model is from the truth, as represented by the measured distance dependent data. The model of estimated radio transmitter positions may then be updated and a new sum of residuals may be calculated, and so forth. This may be repeated for a fixed number of repetitions or until the sum of residuals goes below a threshold value.

Once the model of estimated radio transmitter positions is finished it may be used to set estimated measurement position 14 and the estimated accuracy 16 of a sample 1 of the estimation labeled type in the training dataset 1. The radio transmitter modelling samples may e.g. together with estimated measurement positions 14 and the estimated accuracies 16 of the last iteration of the model of estimated radio transmitter positions form part of the training dataset 1 for training S160 the neural network 20. Alternatively, or additionally, when the model of estimated radio transmitter positions is finished, new distance dependent data may be inputted into the model such that new estimated measurement positions 14 and new estimated accuracies 16 are received. The new distance dependent data and the new estimated measurement positions 14 and the new estimated accuracies 16 may then form new samples 10 for training S160 the neural network 20. Forming such new samples may be done for one sample 10 at a time or for a plurality of samples 10 at a time. Alternatively, or additionally, when the model of estimated radio transmitter positions is finished, new distance dependent data may be used together with the model to find new estimated measurement positions 14 and the estimated accuracies 16 through triangulation.

As seen in FIG. 2, setting S120″ the estimated measurement position 14 and the estimated accuracy 16 of a sample 10 of the estimation labeled type in the training dataset 1 may be performed by:
receiving S126 a known position and relative movement data, the relative movement data indicating movement between the known position and the measurement position associated with said sample 10 of the estimation labeled type; and
   calculating S127 the estimated measurement position 14 and the estimated accuracy 16 to be set for said sample 10 of the estimation labeled type based on the known position and the relative movement data.

The known position may be a manually set position or a GPS position measured at an earlier time and the relative movement data may e.g. be data from an inertial measurement unit that has recorded data along a path from the known position to the measurement position. Thus, the measurement position may be estimated from the known position and the relative movement data. The estimated measurement position may e.g. be calculated through dead reckoning.

As described in conjunction with step S120′ and S120″ the estimated measurement position 14 and the estimated accuracy 16 of a sample 10 may be calculated. Additionally, or alternatively, the estimated measurement position 14 and the estimated accuracy 16 of a sample 10 may be received. As seen in FIG. 2 setting S120″ the estimated measurement position and the estimated accuracy of each of a plurality of samples of the estimation labeled type in the training dataset may be done by receiving S124 Global Navigation Satellite System data for the measurement position. The estimated measurement position may herein be the GNSS position. The estimated 2D accuracy may herein be the GPS estimated accuracy or the horizontal dilution of precision (HDOP) for said GNSS position, and respectively, the vertical accuracy may be the GPS estimated altitude accuracy or the vertical dilution of precision (VDOP).

Before receiving S150 the training dataset 1 some preprocessing may be done. Preprocessing may be done at the same computing unit that receives S150 the training dataset 1 and performs the training S160 of the neural network 20. Alternatively, preprocessing may be performed on a separate computing unit.

A candidate training dataset comprising samples 10 of the estimation labeled type may be received S130.

Samples 10 from the candidate dataset to be included in the training dataset 1 may be selected S132. A sample 10 with a high estimated accuracy 16 may be selected to be included in the training dataset 1 and a sample 10 with a low estimated accuracy 16 may be rejected from being included in the training dataset 1.

The estimated accuracy 16 of samples 10 of the candidate training dataset may be compared S134 to a threshold accuracy. Samples 10 from the candidate training dataset having worse estimated accuracy 16 than the threshold accuracy may be rejected S136 from being included in the training dataset 1. The threshold accuracy may have a value between 0 and 30 meters.

Some samples, e.g. samples from a candidate training dataset may be augmented S140 before including S148 the augmented sample 10 in the training dataset 1. Augmenting S140 may be done by e.g.:
introducing noise to sensor data 12 of a sample 10; and/or
   removing part of the sensor data 12 of a sample 10, reflecting changes in the environment or missed RSS sensor data due to timing of a scan; and/or
   introducing a RSS offset to the sensor data 12 of a sample 10, reflecting differences in RSS calibration and/or antenna performance.

Preprocessing may additionally, or alternatively, comprise normalizing, e.g. normalizing RSS data. RSS data may be normalized into the range [0,1]. Alternatively, RSS data may be normalized by subtracting the mean and dividing by the estimated standard deviation. Normalizing may provide better training performance and high training stability, depending on the properties of the original signal. In the case of WiFi AP RSS, the common situation may be to normalize measurements from the interval [−100,0] to [0,1]. Missing values may in this case be assigned the value 0. Each of the N beacons may give rise to a unique input to the neural network 20, which means that if for example 200 such beacons have been detected in the training phase, the input dimension may be 200 for all measurements.

The created model for positioning within an environment may after training be used for real-time positioning. For example, RSS measurements of WiFi APs and/or BLE beacons may be used to directly receive a most likely position. It has been seen that the computational effort for creating a position may be much lower than for doing a corresponding position calculation using kNN fingerprinting algorithms. Thus, the created model may be better suited for high volume low latency positioning at the expense of the non-time-critical training effort.

Depending on the device that is being positioned, there may be access to additional sensor measurements during online positioning, in addition to the sensors that were used for generating the above positioning model. This can for example be inertial sensors that measure how the device is moving in some frame of reference. If the same measurements are also available during the above collection of a dataset these can be included in the model, for example in a recurrent neural network. Such measurements can also be combined with the above model independently. One way to do this is to use methods based on the Kalman filter and/or Kalman smoother equations.

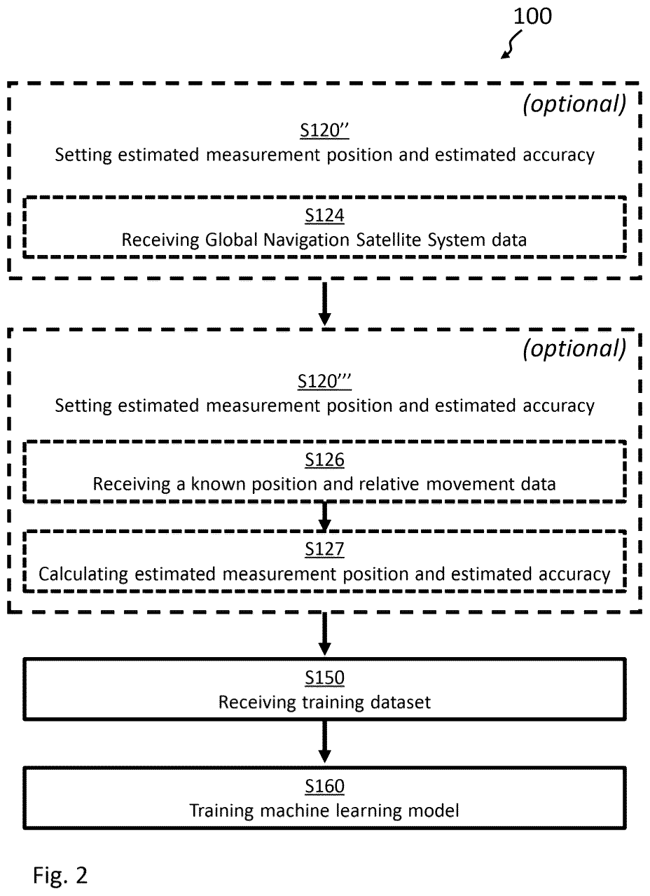

FIG. 4 illustrates a flowchart of a method 200 for positioning within an environment.

The method 200 comprises acquiring S202 sensor data 12, measured at the position of the device, the sensor data 12 being characteristic of the position of the device. The sensor data may be the same type of sensor data 12 that has been used for training the neural network 20.

The method 200 further comprises accessing S204 the model, for positioning within the environment, that is described above.

The method 200 further comprises determining S206 the position 30 of the device based on the acquired sensor data 12 and the accessed model.

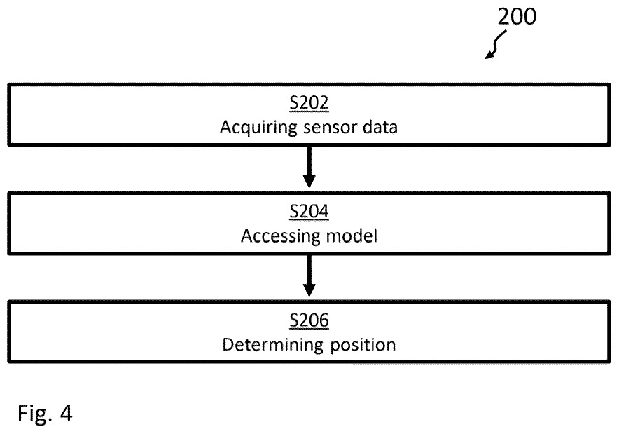

As an example, the method may be performed by a device, e.g. a mobile phone, acquiring S202 sensor data 12 such as RSS data at the position of the device. The model may then be accessed S204 e.g. by the device sending the sensor data 12 to a server comprising a neural network 20 that has been trained on that type of data. In this case the neural network 20 may have been trained on RSS data (it may additionally have been trained to handle also other types of sensor data). Alternatively, the neural network 20 may be situated on the device itself. The neural network 20 may e.g. have been trained on a server and then transferred to the device after training. The sensor data 12 may be inputted to the neural network 20 and the neural network 20 may then output the position 30 of the device as [\hat{x}, ŷ, \hat{f}]. This is illustrated in FIG. 6.

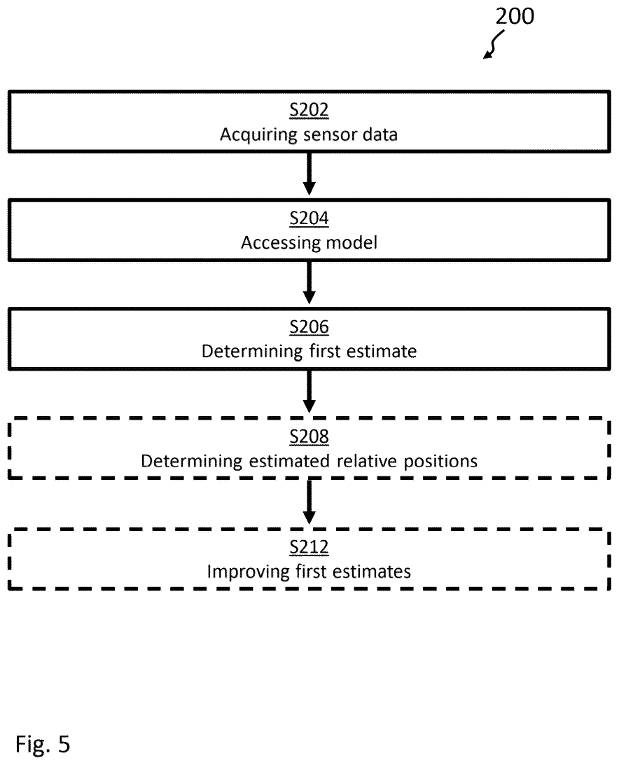

A plurality of positions 30 of the device may be determined along a track 40. This may be done by for each separate position determining S206 the position 30 of the device directly from the output from the neural network 20, as illustrated in FIG. 7.

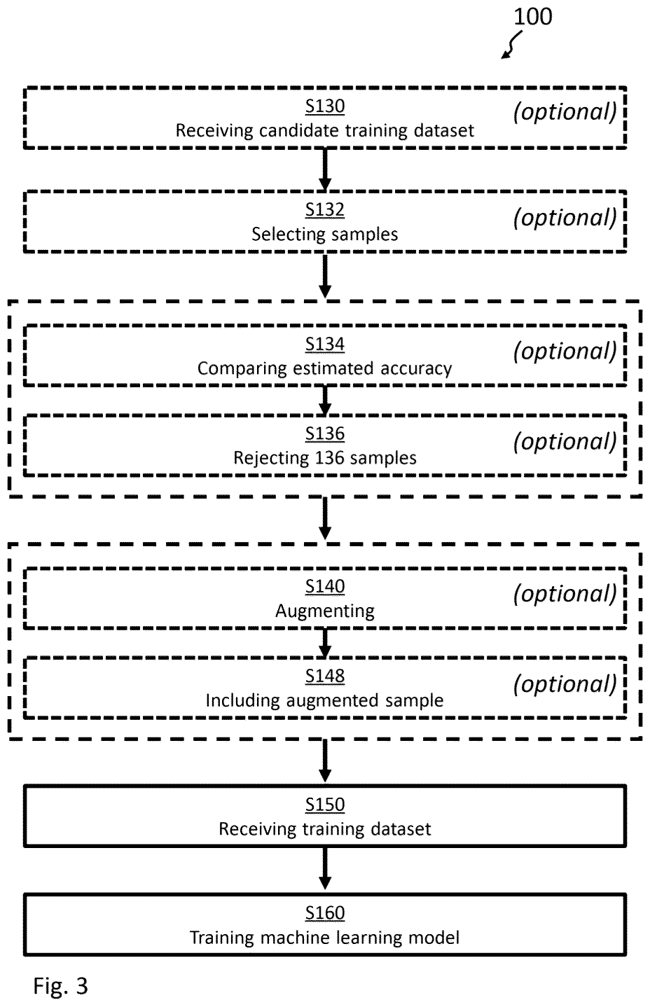

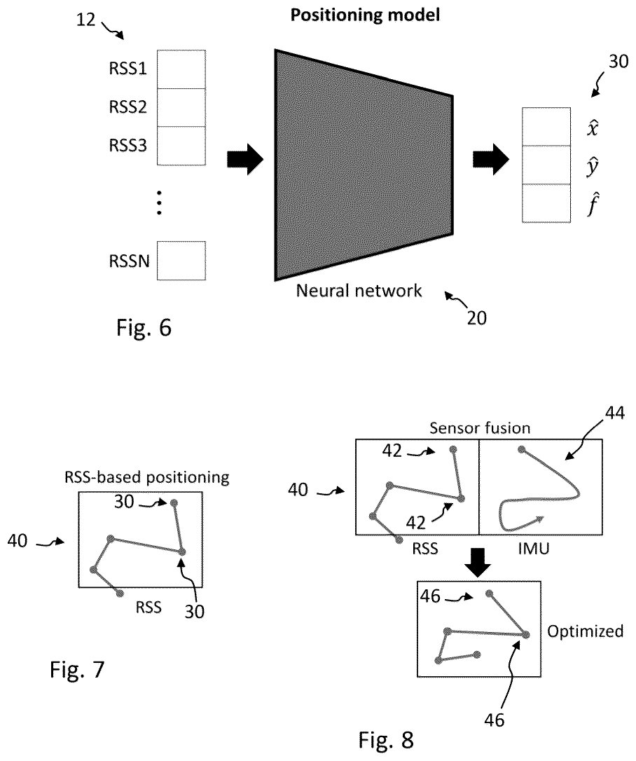

Alternatively, the output from the neural network 20 may be combined with relative movement data 44 for better positioning, as illustrated in FIG. 8. A flowchart of this is illustrated in FIG. 5. Herein, the output from the neural network 20 may be taken as a first estimate 42 for each position 30 of the device. Relative movement data 44 associated with the plurality of positions 30 along the track 40 may then be received. For example, both sensor data 12 and relative movement data 44 may be received, e.g. simultaneously, by a computing unit, e.g. a server or a computing unit on the device itself, that performs the positioning.

Estimated relative positions of the positions 30 along the track 40 may be determined S208 based on the relative movement data 44. Estimated relative positions of the positions 30 along the track 40 may be determined S208 e.g. using a neural network (such as a neural network model separate from the neural network 20 that herein is described to generate the first estimate 42) or using a conventional computer program. The first estimates 42 for each position 30 of the device may then be improved S212 using the estimated relative positions.

One way to improve S212 the first estimates 42 for each position 30 of the device using the estimated relative positions may be to use optimization based on the Kalman smoother, as shown in the following example. The example is in 2D. As understood by the skilled person, the example is also applicable in 3D. Consider a number of first estimates 42 \hat{p}ᵢ and estimated relative positions \hat{Δ}ₚᵢ. The positions based on the first estimates 42 may differ slightly from positions based on relative movement data 44, as seen in FIG. 8. The relative movement data 44 in FIG. 8 is IMU data but may alternatively be e.g. a heading and a step count between two positions along the track.

In this example, the optimization problem that is solved to improve estimates of positions may be given by

$${argmin}_{p} \frac{1}{{s}_{1}^{2}} {\sum }_{i = 1}^{K} {‖ {p}_{i} - \hat{{p}_{ι}} ‖}^{2} + \frac{1}{{s}_{2}^{2}} {\sum }_{i = 1}^{K - 1} {‖ {p}_{i + 1} - {p}_{i} - ‖}^{2} ,$$

where there are K subsequent estimated points \hat{p} to be improved by use of K−1 estimated movements between these points [symbol] . Herein, pᵢ=[xᵢ, yᵢ] and \hat{p}ᵢ=[\hat{x}ᵢ, ŷᵢ]. Further, Api represents the relative movement, according to the relative movement data 44, between \hat{p}ᵢ and \hat{p}ᵢ₊₁. Further, this exemplified optimization problem is weighted by s₁ and s₂ which are the estimated standard deviations (in 2D) of the model errors, which could be estimated based on model performance on validation and/or test sets. s₁ relates to the errors in position estimates \hat{p} and s₂ relates to the errors in relative movement estimates [symbol] .

As described above, the method for positioning may be performed by a device, such as a mobile phone, for positioning of the device itself. This implies that communication between the device and a server for positioning of the device may be avoided such that power consumption of the device for positioning of the device may be small. Thus, it should be realized that a low power consumption of the device may be achieved for the device being configured to position itself, regardless of the positioning model being used. Thus, the method for positioning of the device being performed by the device could be advantageously used with any positioning model and need not necessarily be used with the model described in detailed above. Rather, the positioning model may for instance be a neural network model that may be trained in a different manner than described above, or a k-nearest neighbor model, such as a weighted k-nearest neighbor model.

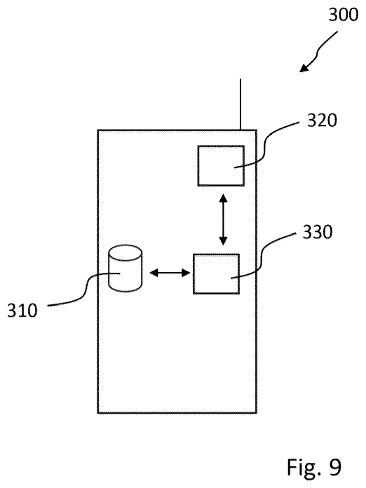

FIG. 9 illustrates a device 300 that is configured to position itself. The device 300 comprises a memory 310 which stores the positioning model. The positioning model may for instance be the neural network 20 or another positioning model. The positioning model may be received from a server or another external unit. Alternatively, the positioning model may be based on training performed by the device 300 such that the positioning model may be generated by the device 300 and thereafter be stored in the memory 310.

The memory 310 may provide temporary storage of the positioning model. Thus, the memory 310 may comprise a volatile memory, which may for instance be implemented as a random-access memory (RAM). The device 300 may be configured to store the positioning model in the volatile memory during use of the positioning model so as to allow fast access to the positioning model.

The memory 310 may further comprise a non-volatile memory, such as an electrically erasable programmable read-only memory (EEPROM) or a read-only memory (ROM). The positioning model may be stored in the non-volatile memory to ensure that the positioning model may be stored for a long period of time on the device 300. The positioning model may be transferred from the non-volatile memory to the volatile memory when the positioning model is to be used.

The device 300 further comprises a sensor 320 configured to acquire sensor data 12. The sensor data 12 may provide a same type of information that was used for training the positioning model. The sensor 320 may be configured to detect wireless signals such that the sensor 320 may be configured to acquire a position-dependent measurement based on a wireless signal transmitted between the device 300 and a radio transmitter in the environment.

The device 300 further comprises a processing unit 330 configured to access the positioning model stored in the memory 310. The processing unit 330 is further configured to receive sensor data 12 from the sensor 320 and to determine a location of the device 300 within the environment. The processing unit 330 may input the sensor data 12 to the positioning model such that processing the sensor data 12 using the positioning model may generate the location of the device 300.

The processing unit 330 may be any suitable unit in the device 300 for processing sensor data. For instance, the processing unit 330 may be a central processing unit (CPU) or a graphical processing unit (GPU) of the device 300, which is provided with software or computer-readable instructions for providing the desired functionality. It should be realized that the processing unit 330 may alternatively be implemented in hardware, such as using an application-specific integrated circuit (ASIC), or as a combination of hardware and software.

The position-dependent measurements of the sensor data 12 may comprise a received signal strength from the radio transmitter. For instance, the position-dependent measurements may comprise RSS data or reference signal received power (RSRP) data.

The position-dependent measurements of the sensor data 12 may also or alternatively comprise a time measurement representing a duration of transmission of the wireless signal between the device 300 and the radio transmitter. For instance, the position-dependent measurements may comprise round trip time (RTT) data or time of arrival (ToA) data, such as downlink time difference of arrival (DL-TDoA) data or multicell round trip time (MC-RTT) data.

The position-dependent measurements of the sensor data 12 may also or alternatively comprise an angular measurement of the device in relation to the radio transmitter. For instance, the position-dependent measurements may comprise angle of arrival (AoA) data.

The positioning model may be any suitable model for determining locations of the device 300 based on characteristics of wireless signals in the environment. The positioning model may for instance represent characteristics of wireless signals in one or more buildings. As mentioned, the positioning model may for instance be a neural network model or a k-nearest neighbor model.

The positioning model may further provide additional information for assisting in determining the location of the device 300. Thus, the positioning model may further comprise mapping information of the one or more buildings represented by the positioning model. The mapping information may provide information of locations of walls and door openings in the building(s).

The mapping information may be used for assisting determining of a location of the device 300. For instance, the device 300 may use the mapping information to prevent unrealistic movements through the building in a sequence of determined locations and/or to promote realistic movements through the building in the sequence of determined locations. Thus, the mapping information may be used as input to prevent subsequent positions within the building to be determined on opposite sides of a wall, corresponding to a jump through a wall. Also, the mapping information may be used as input to promote subsequent positions to follow natural paths through the building, such as through door openings.

The device 300 may be configured to manage positioning models being stored in the memory 310.

The device 300 may be configured to receive the positioning model from a remote unit, such as a remote unit in which the positioning model is trained and generated. The positioning model may be received from a server.

The device 300 may further be configured to store the positioning model in the memory 310 providing access to the positioning model. The positioning model may at least be temporarily stored in the memory 310.

The device 300 may request the positioning model representative of a particular area. The device 300 may request the positioning model when entering the particular area. Alternatively, a user may request the positioning model for a particular area in advance, e.g., based on plans to visit the area.

The positioning model may be provided by the server to the device 300 based on the request. Alternatively, the positioning model may be provided by the server based on the server identifying that the device 300 is about to enter the area represented by the positioning model using position information of the device 300, such as GPS positions of the device 300.

The device 300 may store a plurality of positioning models. The device 300 may thus be configured to use the positioning model that is representative of the area in which the device 300 is presently located. The device 300 may store the positioning models such that the device 300 may re-use the positioning model representing a particular area during different occasions of the device 300 being in the particular area.

The device 300 may thus be able to identify which positioning model to be used at a particular point in time. The device 300 may identify which positioning model to be used based on a global position of the device 300, such as based on a GPS position. The positioning model may also be associated with global position information allowing identifying of the positioning model to be used.

The device 300 may be configured to select the positioning model to be used among the plurality of positioning models stored in the memory 310. The positioning model may be selected based on position information of the device 300, e.g., by matching a global position of the device 300 to global position information of the positioning model.

The device 300 may further be configured to request an update of the positioning model. The device 300 may for instance be configured to ask the server whether an updated positioning model is available. The server may be configured to continuously update positioning models based on updated training data being received from devices moving in the area represented by the positioning model.

The updating of the positioning model may be triggered by an updating condition. The updating condition may correspond to the positioning model being accessed. Thus, each time the device 300 enters an area represented by a stored positioning model, the device 300 may request an update. The updating condition may correspond to an age of the positioning model, such that the device 300 may request an update when an age of the positioning model is larger than a threshold value. The updating condition may also correspond to a condition relating to communication between the device 300 and the server. Thus, the updating condition may correspond to the device 300 being connected to an external power supply, or the device 300 being able to communicate efficiently with the server, such as the device 300 being connected to Wi-Fi.

The server may identify availability of an updated positioning model and provide the updated positioning model to the device 300. The server may identify the updated positioning model based on receiving the request from the device 300. The device 300 may thus receive the updated positioning model from the server and may replace a current positioning model by the updated positioning model.

The device 300 may further be configured to ensure that only relevant positioning models are stored in the memory 310. Thus, the device 300 may be configured to remove positioning model(s) stored on the device 300.

The positioning models may be removed based on a removing condition. Thus, the device 300 may be configured to determine that a time since latest use of the positioning model is larger than a threshold or that an age of the positioning model is larger than a threshold for identifying that the positioning model is to be removed from the memory 310. The device 300 may also or alternatively determine that a frequency of use of the positioning model is lower than a threshold for identifying that the positioning model is to be removed from the memory 310. Thus, seldom-used positioning model(s) may be removed.

Since the device 300 is configured to determine its location, the device 300 may efficiently use any data available from sensors of the device 300. The data need not be transmitted through communication with a remote unit. Thus, the use of additional sensor data for positioning of the device 300 does not have a large effect on power consumption of the device 300.

Thus, the use of additional sensor data for improving determination of the location of the device 300 as described above in relation to FIGS. 5 and 8 may be particularly useful in the device 300 that determines its own location.

The device 300 may be configured to acquire additional sensor data using any additional sensor available on the device 300. Thus, the additional sensor data may for instance be accelerometer data, gyroscope data, magnetometer data, step counter data and/or pressure sensor data.

The device may use sensor fusion for combining the additional sensor data with the determination of the location or a sequence of locations of the device 300 using the positioning model. The device 300 may be configured to use a filter, such as a Kalman filter or particle filter, for taking previous locations of the device 300 into account when determining a current location of the device 300.In the above the inventive concept has mainly been described with reference to a limited number of examples. However, as is readily appreciated by a person skilled in the art, other examples than the ones disclosed above are equally possible within the scope of the inventive concept, as defined by the appended claims.

### Embodiments

A1. A method for creating a model for positioning within an environment, the method comprising:
receiving a training dataset comprising samples of an estimation labeled type, each sample of the estimation labeled type being associated with a measurement position in the environment, each sample of the estimation labeled type comprising
   sensor data, measured at the measurement position associated with the sample, the sensor data being characteristic of the measurement position associated with the sample;
   an estimated measurement position, being an estimate of the measurement position associated with the sample;
   an estimated accuracy, being an estimate of an accuracy of the estimated measurement position;
training a machine learning model to convert sensor data to a position in the environment, wherein the training is based on the samples of the estimation labeled type in the training dataset, whereby the model for positioning within the environment is created.

A2. The method of embodiment A1, wherein the sensor data of at least one sample comprises distance dependent data, the distance dependent data comprising an indication of a distance between the measurement position associated with the at least one sample and a radio transmitter.

A3. The method of embodiment A1 or A2, wherein the sensor data comprises received signal strength (RSS) data from one or more radio transmitters in the environment.

A4. The method of any one of embodiments A1-A3, further comprising
setting the estimated measurement position and the estimated accuracy of a sample of the estimation labeled type in the training dataset by:
   receiving a model of estimated radio transmitter positions in the environment;
   calculating the estimated measurement position and the estimated accuracy to be set for said sample of the estimation labeled type based on distance dependent measurements to the transmitters and the model of estimated radio transmitter positions.

A5. The method of embodiment A4, further comprising
generating the model of estimated radio transmitter positions by:
   receiving radio transmitter modelling samples, each radio transmitter modelling sample being associated with a measurement position in the environment or in the vicinity of the environment, each radio transmitter modelling sample comprising:
      distance dependent data, measured at the measurement position associated with the radio transmitter modelling sample, the distance dependent data comprising an indication of a distance between the measurement position of the radio transmitter modelling sample and a radio transmitter;
   forming a candidate model of estimated radio transmitter positions and estimated measurement positions of the radio transmitter modelling samples based on the received radio transmitter modelling samples and a plurality of defined positions for samples and/or for radio transmitters;
   iteratively reducing a sum of residuals for said candidate model, wherein at least one residual is based on, for at least one sample of the received radio transmitter modelling samples, a difference between
      an estimated distance between the measurement position of said at least one sample and a radio transmitter as represented by the model and
      a measured distance between the measurement position of said at least one sample and the radio transmitter as represented by the distance dependent data of said at least one sample, for generating a model of estimated radio transmitter positions.

A6. The method of any one of embodiments A1-A5, further comprising
setting the estimated measurement position and the estimated accuracy of a sample of the estimation labeled type in the training dataset by:
receiving a known position and relative movement data, the relative movement data indicating movement between the known position and the measurement position associated with said sample of the estimation labeled type;
calculating the estimated measurement position and the estimated accuracy to be set for said sample of the estimation labeled type based on the known position and the relative movement data.

A7. The method of any one of embodiments A1-A6, wherein the training of the machine learning model is configured to modify the machine learning model more strongly for samples of the estimation labeled type that have high estimated accuracy than for samples of the estimation labeled type that have low estimated accuracy.

A8. The method of embodiment A7, wherein the training of the machine learning model comprises
calculating, by a loss function, a loss, the loss being based on, for at least one sample of the estimation labeled type in the training dataset, a representation of a difference between
   the position converted by the machine learning model from sensor data of said at least one sample; and
   the estimated measurement position of said at least one sample;
modifying the machine learning model based on the loss; wherein the loss function is configured to weigh the impact of said representation of said difference on the loss based on the estimated accuracy of said at least one sample, whereby the training modifies the machine learning model more strongly for a high estimated accuracy than for a low estimated accuracy.

A9. The method of any one of embodiments A1-A8, further comprising
receiving a candidate training dataset comprising samples of the estimation labeled type;
selecting samples from the candidate dataset to be included in the training dataset, wherein, in at least a sub-environment of the environment, a sample with a high estimated accuracy is selected to be included in the training dataset and a sample with a low estimated accuracy is rejected from being included in the training dataset.

A10. The method of any one of embodiments A1-A9, further comprising
receiving a candidate training dataset comprising samples of the estimation labeled type;
comparing estimated accuracy of samples of the candidate training dataset to a threshold accuracy;
rejecting samples from the candidate training dataset having worse estimated accuracy than the threshold accuracy from being included in the training dataset, wherein the threshold accuracy has a value between 0 and 30 meters.

A11. The method of any one of embodiments A1-A10, wherein the environment for the positioning is a building and the estimated measurement position includes a height or a floor indicator.

A12. The method of any one of embodiments A1-A11, the method further comprising
augmenting at least one sample of the estimation labeled type, wherein said augmenting comprises:
   introducing noise to sensor data of said at least one sample; and/or
   removing part of the sensor data of said at least one sample; and/or
   introducing an RSS offset to the sensor data of said at least one sample;
including the at least one augmented sample in the training dataset before training the machine learning model.

A13. The method of any one of embodiments A1-A12, wherein the training dataset further comprises samples of an unlabeled type, each sample of the unlabeled type being associated with an unknown measurement position in the environment, each sample of the unlabeled type comprising
sensor data, measured at the unknown measurement position associated with the sample, the sensor data being characteristic of the unknown measurement position associated with the sample; wherein the training of the machine learning model is further based on the sensor data of samples of the unlabeled type in the training dataset.

A14. A method for positioning a device within an environment, the method comprising:
acquiring sensor data, measured at the position of the device, the sensor data being characteristic of the position of the device;
accessing a model for positioning within the environment, wherein the model has been created according to the method of any one of embodiments A1-A13;
determining the position of the device based on the acquired sensor data and the accessed model.

A15. The method according to embodiment A14, the method comprising determining a plurality of positions, of the device, along a track, wherein sensor data is acquired for each of the positions along the track, said method further comprising:
determining a first estimate for each position along the track based on the acquired sensor data for each position and the accessed model;
determining estimated relative positions of the positions along the track based on relative movement data, the relative movement data indicating movement between at least two positions along the track;
improving the first estimates for each position along the track using the estimated relative positions.

1. A method in a device for positioning of the device within an environment, said method comprising:
accessing a positioning model stored on the device, wherein the positioning model is based on training of positioning in the environment and represents characteristics of wireless signals in an area in which the device is located;
acquiring sensor data by one or more sensors of the device, wherein the sensor data comprises position-dependent measurements for one or more positions of the device, wherein each position-dependent measurement relates to a wireless signal transmitted between the device and a radio transmitter arranged in the environment; and
determining a location of the device within the environment based on inputting of the sensor data to the positioning model.

2. The method according to claim 1, wherein the position-dependent measurements comprise one or more of: a received signal strength from the radio transmitter, a time measurement representing a duration of transmission of the wireless signal between the device and the radio transmitter, or an angular measurement of the device in relation to the radio transmitter.

3. The method according to claim 1, wherein the positioning model is a neural network model or a k-nearest neighbor model.

4. The method according to claim 1, further comprising:
receiving the positioning model from a server, and
storing the positioning model on the device.

5. The method according to claim 4, further comprising:
requesting an update of the positioning model from the server;
receiving an updated positioning model; and
replacing the positioning model stored on the device by the updated positioning model, wherein the requesting of the update of the positioning model is triggered by an updating condition.

6. The method according to claim 1, wherein a plurality of positioning models representing different areas is stored on the device, and wherein accessing the positioning model comprises selecting the positioning model among the plurality of positioning models based on position information of the device.

7. The method according to claim 1, wherein a plurality of positioning models is stored on the device, the method further comprising determining a plurality of candidate locations, wherein each of the plurality of candidate locations is determined based on inputting of the sensor data to a respective one of the plurality of positioning models, and wherein the determining of the location is based on the plurality of candidate locations.

8. The method according to claim 6, further comprising removing one or more positioning models from the plurality of positioning models stored on the device based on a removing condition.

9. The method according to claim 1, further comprising acquiring additional sensor data, such as one or more of accelerometer data, gyroscope data, magnetometer data, step counter data, or pressure sensor data, wherein the determining the location of the device is further based on the additional sensor data.

10. The method according to claim 9, wherein the additional sensor data is input to the positioning model, or wherein the determining the location of the device comprises combining an output from the positioning model with the additional sensor data.

11. The method according to claim 1, wherein determining the location of the device comprises determining a sequence of locations of the device using a filter, such as a Kalman filter or a particle filter, for taking previous locations in the sequence into account in determining a current location of the device.

12. The method according to claim 1, wherein the positioning model represents characteristics of wireless signals in one or more buildings in the area.

13. The method according to claim 12, wherein the positioning model comprises mapping information of the one or more buildings, wherein the determining the location of the device is further based on information of structures, such as walls, in the mapping information.

14. The method according to claim 1, wherein the method is used for one or more of: positioning of the device, determining a relation of the location of the device to a geofence, or tracking of the device along a sequence of locations.

15. A computer program product comprising computer-readable instructions which, when executed on a processing unit, will cause a processing unit to perform the method according to claim 1.

16. A device, comprising:
a memory storing a positioning model, wherein the positioning model is based on training of positioning in an environment and represents characteristics of wireless signals in an area in the environment;
a sensor configured to acquire sensor data, wherein the sensor data comprises position-dependent measurements for one or more positions of the device, wherein each position-dependent measurement relates to a wireless signal transmitted between the device and a radio transmitter arranged in the environment; and
a processing unit configured to:
access the positioning model;
receive the sensor data; and
determine a location of the device within the environment based on inputting of the sensor data to the positioning model.
